(19) United States
(12) Patent Application Publication
(10) Pub. No.: US 2016/0245273 A1
(43) Pub. Date: Aug. 25, 2016

(54) ELECTRONIC CONTROL DEVICE FOR A COMPONENT OF COMPRESSED-AIR GENERATION, COMPRESSED-AIR PROCESSING,COMPRESSED-AIR STORAGE, AND/OR COMPRESSED-AIR DISTRIBUTION

(71) Applicant: KAESER KOMPRESSOREN SE, Coburg (DE)

(72) Inventor: Florian WAGNER, Coburg (DE)

(21) Appl. No.: 15/028,262

(22) PCT Filed: Oct. 1, 2014
(86) PCT No.: PCT/EP2014/071053

§ 371 Date: Apr. 8, 2016

(30) Foreign Application Priority Data
Oct. 10, 2013 (DE) 10 2013 111 218.8

(51) Int. Cl. F04B 49/06; G05B 13/04

(52) U.S. Cl. CPC F04B 49/065; G05B 13/048

(57) ABSTRACT

The invention relates to an electronic control device for a component of compressed-air generation, compressed-air processing, compressed-air storage, and/or compressed-air distribution, wherein the electronic control device (11) falls back upon one or more models, which, as component-related models, contain information relevant to the structure, or the behavior of the component (12), in order to determine, simulate, or evaluate operation-relevant data and performs, as an evaluation purpose, either—open-loop control, closed-loop control, diagnosis, and/or monitoring of the component or—a determination, provision, prediction, or optimization of operating data, operating states, operating modes, operating behaviors, and/or operating effects on the basis of the models in a concrete evaluation routine, and wherein current or historical structure information operating data, operating states, and/or measurements/sensor values of the component at least partially available in the electronic control device are used as initial values.

The invention relates to an electronic control device for a component of compressed-air generation, compressed-air processing, compressed-air storage, and/or compressed-air distribution, and to a method for controlling, regulating, diagnosing, and/or monitoring a component of compressed-air generation, compressed-air processing, compressed-air storage, and/or compressed-air distribution, according to the features of claim 1 and according to the features of claim 28, respectively.

Methods for controlling an entire compressor system are already known in the prior art, cf. WO 2010/072808. Here, a central control device controls and monitors a multiplicity of components for compressed air generation and/or compressed-air processing, wherein an at times substantial flow of data to and from the control device has to be handled.

As opposed to the above-mentioned prior art, the present invention is based on the object of providing an electronic control device and a method for controlling, regulating, diagnosing and/or monitoring in connection with compressed-air generation, compressed-air processing, compressed-air storage, and/or compressed-air distribution, in which a central control device which is provided in the prior art may be relieved, or in which controlling, monitoring, evaluating, diagnosing, etc. are possible in an even more accurate manner.

This object is achieved according to the invention by an electronic control device having the features of claim 1, or by a method for controlling, regulating, diagnosing, and/or monitoring a component of compressed-air generation, compressed-air processing, compressed-air storage, and/or compressed-air distribution, having the features of claim 28. Advantageous refinements are provided in the dependent claims.

In terms of the device, and in accordance with a core concept of the present invention, an electronic control device is provided for a component of compressed-air generation, compressed-air processing, compressed-air storage, and/or compressed-air distribution, wherein the electronic control device for determining, replicating, or evaluating operationally relevant data refers back to one or a plurality of models which as component-related models contain items of information which are relevant to the structure or to the behavior of the component, and by means of the models as an evaluation purpose in a specific evaluation routine either performs controlling, regulating, diagnosing, and/or monitoring of the component, or determining, providing, predicting, or optimizing operational data, operational states, operational modes, operational behavior, and/or operational effects, and wherein current or historical items of structural information, operational data, operational states, and/or measured values/sensor values of the component which are at least in part available in the electronic control device are used as initial values.

In terms of the method, and in accordance with the invention, a method for controlling, regulating, diagnosing, and/or monitoring a component of compressed-air generation, compressed-air processing, compressed-air storage, and/or compressed-air distribution, wherein the component interacts with an electronic controller in particular as claimed in one of claims 1 to 27, wherein for determining, replicating, or evaluating operationally relevant data reference is made back to models which as component-related models contain items of information which are relevant to the structure or to the behavior of the component, and current or historical items of structural information, operational data, operational states, and/or measured values/sensor values of the component which are at least in part available in the electronic control device are used as initial values.

According to the invention, an effect is directly exerted on components of compressed-air generation, compressed-air processing, compressed-air storage, and/or compressed-air distribution, wherein for determining, replicating, or evaluating operationally relevant data, reference is made back to models relating to components. The electronic control device here may be implemented entirely within the respective component and may be provided on the component so as to be self-sufficient or to interact with another control device, for example with a control device of an overall system, or with a further externally provided control device.

To this extent, the invention may already be implemented when the proposed control device is provided so as to be self-sufficient on one component, or when the proposed method is carried out thereon. However, in another alternative, the invention is also implemented when the electronic control device acts on the component, or when the proposed method is carried out when the component is integrated in an overall system, potentially communicating also with a control device of the overall system. In this implementation possibility, the electronic control device of the component may in certain circumstances also be entirely or almost entirely implemented in the control device of the overall system.

The control device of the overall system, or the central control device, respectively, in the context of the present application may be understood, for example, to be (only) a superordinate control device of the overall system comprising the interlinked components of compressed-air generation, compressed-air processing, compressed-air storage, and/or compressed-air distribution, or else a control device that is at an even higher level. Such a superordinate control device here may be implemented—in certain circumstances only in part—in an external data center and/or in a cloud.

By way of this concept the present invention achieves the object set at the outset of relieving a central control device provided in the prior art, specifically independently of whether the latter is a superordinate control device of the system, or a control device which is at an even higher level, for example a superordinate (master) system.

A component of compressed-air generation, compressed-air processing, compressed-air storage, and/or compressed-air distribution hereunder is understood to be an individual apparatus such as a compressor, a compressed-air filter, a compressed-air dryer, or a compressed-air reservoir. However, taking a more general view, a component may also be understood to be a unit formed from at least two individual apparatuses, for example a compressed-air generation and purifying unit formed from a compressor and a compressed-air filter. Finally, a component may also be understood to be a part of an apparatus, such as a part of a compressor, for example. In a multistage compressor a single compressor stage may also be viewed as being a component, for example.

A model of a component is understood to be a simplified idealizing or approximate view of the real behavior and/or of the real structure of a component. Here, both the term structure as well as the term behavior are to be understood to be very comprehensive. A structure may be understood to be the real construction of a component. However, the structure may also comprise, for example, linking or the hierarchy of individual sub-components in terms of circuitry, respectively. The behavior of components is also to be understood to be the behavior when exposed to given external influences, for example electric power consumption expressed at market prices, for instance in a comparison between two situations in which the actual technical behavior of the component is identical but in which the market prices for the required electric power differ between a first situation and a second situation.

The term models also comprises part-models. As has been mentioned at the outset, components also comprise part-components. To the extent that controlling, regulating, diagnosing, and/or monitoring of a part-component is being discussed, it may suffice to deduce a part-component model which is representative for the evaluation purpose and for the part-component. However, the part-component model may also be more comprehensive, that is to say depict more than only one part-component, or be more specific, that is to say describe less than one part-component, respectively.

In one specifically preferred design embodiment, the electronic control device, depending on the evaluation purpose, performs variable configurations of the component models or else of part-component models, and/or of the type, the number, the sequence, and/or the scenarios of the evaluation.

In a furthermore potential and non-mandatory design embodiment, the component model or else the part-component model is adapted to the properties and/or the operational parameters of the (part-) component(s) that have to be specifically considered in the respective evaluation by parameterization or configuration, respectively, wherein this adapting may be performed in particular manually, part-automatically, or automatically.

Adapting is required or at least meaningful, respectively, in the case of operational parameters, and/or properties of the components, and/or properties of the part-components, which are modified and/or are preliminary and only approximately known. In the context of automatic adapting, models (i.e. the model to be adapted or another model/other models) may in turn be applied, in particular in that by way of iteratively adapted applications of models the properties and/or operational parameters to be updated are determined such that the best possible conformity between the model behavior and the real observed behavior and/or a notional future behavior is achieved.

According to a further advantageous aspect of the present invention, by means of the models also operational data, operational states, and or state quantities of the component, for which the measured values/sensor values are not or not yet available, are carried over and/or deduced in the evaluation process. In this design embodiment, one resorts in particular to a “virtual sensor”, that is to say that operational data, operational states, and/or state quantities are deduced or provided, respectively, while using models without a physical sensor having to sense the actual conditions. By way of this procedure it is possible for savings to be made in sensors or to refer back to values for which the sensors are not available, or for which the latter would only be able to be implemented with disproportionally high complexity, respectively.

In a further design embodiment of the electronic control device it is provided that, depending on the evaluation purpose, reference is made back to variable initial values, and/or variable initialization time points are chosen. In one potential design embodiment of the present invention it is provided that the evaluation process takes place during operation of the component, in particular under direct interaction, that is to say while considering the current operational behavior of the components prior to, during, or subsequent to the respective operational behavior of the component.

In one potential design embodiment of the present invention the evaluations are fully or partially composed of the analysis of models, in particular of the analysis of logical models. The component models may be present as physical, logical, structural, stochastic, monetary, empirical, appraised, and/or models combined from these categories.

As has been mentioned at the outset, the electronic control device may be at least partially, but in particular may also be entirely configured as a controller which is integrated in the component for compressed-air generation, compressed-air processing, compressed-air storage, and/or compressed-air distribution. However, it is also possible that it is at least partially not configured within the component for compressed-air generation, compressed-air processing, compressed-air storage, and/or compressed-air distribution. For example, it is possible that the electronic control device is at least partially implemented in a superordinate controller, specifically in a superordinate controller of the system, comprising interlinked components of compressed-air generation, compressed-air processing, compressed-air storage, and/or compressed-air distribution, and/or in a superordinate (master) system. Individual calculating steps or evaluation steps, or all thereof, respectively, here may also be carried out externally in a data center and/or in a cloud.

However, in one potential design embodiment the electronic control device may also be composed of a plurality of electronic controllers which are interconnected by data exchange. In one specific potential design embodiment the models are implemented exclusively in the electronic control device per se. However, it is also possible that the models are distributed across a plurality of electronic control devices which are interconnected by data exchange.

Carrying out, processing, and/or using the evaluations may be implemented in the electronic control device per se. However, it is also possible for carrying out, processing, and/or using the evaluations to be distributed across a plurality of electronic control device which are interconnected by data exchange, in particular also in the form of a respective process being performed by way of cooperation between a plurality of electronic control devices which are interconnected by data exchange.

In one potential design embodiment the evaluations are fully or partially composed of the analysis of models, in particular of the analysis of structural models.

In one potential design embodiment of the present invention the evaluation routines which are specifically capable of being carried out comprise the execution of simulations by calculating or estimating the temporal development of operational data, operational states, and/or state quantities of the component, in particular by the numerical integration over time of model equations.

In one potential design embodiment the operational data, operational states, and or state quantities of the components, which are used and/or deduced when carrying out the evaluations, for which sensor values are not or not yet available, comprise the state of servicing, of wear, or of aging of the component, state quantities for which current values are not measurable or measurable only in a limited manner, and/or of which the values depend on the entire temporal profile of the operation of the component since the last service or refurbishment, or state quantities which are only detectable, in particular measurable, in an inaccurate, cost-intensive, and/or error-prone manner. To this extent, the most varied evaluations may be performed by way of the “virtual sensor” concept, without the actual state quantities having to be physically detected by means of specific sensors.

In one potential design embodiment configuring of the models is performed in such a manner that it is performed by adapting the model structure depending on the part-components which are occasionally (optionally) contained in the component or are in operation, and that it includes a parameterization. Depending on the evaluation purpose, part-components of the component while configuring a model may either be fully ignored, be represented in a highly simplified part-model, or else be considered by parameterization in another part-model, or in the model to be configured, respectively.

In one specific design embodiment configuring of the models may be performed by adapting the model structure depending on the part-components which are occasionally (optionally) contained in the component or are in operation, wherein adapting the model structure in particular includes parameterization. As has been mentioned at the outset, one or a plurality of part-component models may be representative of a respective part-component. However, it may also be possible that part-models have a wider or smaller scope, that is that they exceed the description of a part-component or depict less than the structure and/or the behavior of a part-component, respectively. However, it may be provided in one specific design embodiment that configuring of the models is performed by linking part-models which are assigned part-components which are at all times and/or occasionally or optionally contained in the component or in operation.

In one specific design embodiment adapting of the model structure may be performed by manual input, in particular at the electronic control device, and/or by transferring configuration data sets and parameter data sets into the electronic control device, and/or in a self-teaching manner by simulations based on iteratively adapted models, and/or based on an Piping and instrumentation diagram of the component, which is stored in the electronic control device. The Piping and instrumentation diagram is preferably embodied as a machine-evaluatable structural model, for example as a graph or as a netlist.

Configuring physical models may preferably be performed based on structural models, in particular while considering Piping and instrumentation diagrams, or based on the Piping and instrumentation diagrams, respectively.

It is also possible here that the Piping and instrumentation diagrams are adapted or reconfigured, respectively, depending on the part-components which are occasionally (optionally) contained or are in operation in the component.

In one potential design embodiment the results of the evaluations which have been carried out by one or a plurality of models are used for initializing evaluations by further models, and/or as predefined determining factors therefor.

Preferably, configuring the type, the number, the sequence, and/or the scenarios of the evaluation comprises simultaneously or sequentially carrying out a plurality of evaluations for alternative future profiles of predefined determining factors, in particular of control commands for changing the operational modes or the operational state, wherein selecting the most favorable profiles of predefined determining factors is performed as a consequence of an appraisal of the evaluation results. Selecting the most favorable profiles here may be performed in a single-stage or in a multi-stage process. In particular, it is conceivable for comparatively unfavorable profiles to be excluded in a preliminary selection, and for only comparatively favorable profiles to be included in a final selection. In one specific design embodiment of the present invention appraising the evaluation results and selecting the most favorable future profiles of predefined determining factors is performed while employing at least one target function which contains one or more of the following criteria:
energy consumption, energy costs,
maximum value of electrical power input,
number of changes of the operational state,
utilizable amount of waste heat, and/or temperature level of the waste heat,
proportional service costs caused in the simulation horizon,
pressure condensation point,
pressure quality.

In one specific potential design embodiment it is provided that controlling and/or regulating of the component comprises implementing the selected most favorable profiles of predefined determining factors.

In one preferred design embodiment it is provided that temporal profiles of operational data, of operational states, and/or of state quantities of the component that have been obtained from evaluations of past time periods or are otherwise predefined, in particular calculated, are compared with real current or historical measured values/sensor values, wherein deviations between evaluation results and measured values/sensor values are used for identifying and diagnosing malfunctions or defects. In this way, a very universal and simultaneously reliable identification and diagnosis of malfunctions or defects of the component is possible.

In one specific design embodiment it is also provided that for diagnosing malfunctions and defects, alternative evaluations with configurations of models that contain variable potential malfunctions or defects are carried out, wherein in a comparison step for identifying the most likely malfunction or the most likely defect, respectively, the respective degree of similarity between alternative evaluation results and real, current or historical measured values/sensor values are drafted, or at least less likely or unlikely error sources (malfunctions and defects), respectively, are excluded as a result of the comparison step, respectively.

To this extent the behavior of the component that is typical of a defect or of a malfunction is modelled and compared with real behavior. Conclusions in terms of comparatively more likely error cause may be made in particular by way of the comparison of a plurality of alternative evaluations for model profiles of various error causes with the real operational behavior. However, it is likewise also possible for only one model profile for a certain error cause to be compared with one real operational behavior and for an appraisal thereby to be issued as to whether an error underlying the respective model is present or how likely such an error is, respectively.

It is furthermore possible in order for malfunctions or defects to be identified, that plausibility criteria for real measured values/sensor values are deduced from structural models, and the adherence of real, current or historical measured values/sensor values to these plausibility criteria is checked. Should the actual values deviate for example from the values which are deemed valid on account of the models by more than one predefined threshold value, this may be gauged as a malfunction, or a respective error message may be issued. Plausibility criteria of this type may in particular include the comparison of temperatures and/or pressures at measuring points which are disposed upstream and downstream of one another in flow paths of media (compressed air, cooling air, cooling water, . . . ), wherein systematic increases or decreases in temperatures and/or pressures arise or are to be expected, respectively, between the measuring points during the trouble-free operation of the components.

In one design embodiment of the present invention the evaluation routines are initialized, carried out, evaluated, and used in an event-driven manner. Generally speaking, the evaluation routines are thus initialized and carried out in an event-driven manner, respectively, wherein here potentially not every individual step is performed in an event-driven manner, for instance by referring back to a given initialization but by then carrying out, evaluating, or using the evaluation routine in an event-driven manner. It is likewise possible for evaluation routines which have already been carried out to be evaluated in only an event-driven manner (in terms of certain criteria), etc. Occasions for evaluation routines to be carried out in an event-driven manner may include in a non-limiting manner, for example: changing predefined determining factors, operations states, and/or operational modes of the component, or a diagnosis which has been self-initiated, demanded, or otherwise initiated. Further examples of events of this type are a malfunction, or occurrence of a defect, a demand from a master system being present, a user demand for an evaluation via the display, an operator demand for heat (utilization of the heat recovery system), . . .

In one other design embodiment, the evaluations may be initialized, carried out, evaluated, and used in a cyclical manner, in particular when calculating control actions, at a frequency of 1*10⁻³ s or less to 1 min, particularly preferably of 2*10⁻³ s to 10 s. An evaluation at high frequency may be considered when the former pertains to calculating control actions or to monitoring the components at least in those cases in which the reaction times of the system are comparatively short. By contrast, low evaluation frequencies may be considered when the focus is on optimizing. Here, a comparatively low frequency, for example a daily, weekly, or monthly cycle suffices in many instances.

A simulation horizon according to requirements may be established in particular when calculating control actions, sad simulation horizon being, for example, 1 s to 15 min, in particular 1 min to 5 min. However, in the case of evaluating using underlying models, a simulation may also be prematurely aborted in the case of certain abort criteria, without the entire simulation horizon being passed through, for example when parameters and/or events depart from a predefined corridor, lie above or below a predefined limit value, respectively, and/or when an envisaged result (for example exceeding/undershooting a limit value, adhering to a target corridor, etc.) has already been reached.

In one preferred design embodiment, special evaluations may be carried out by a superordinate electronic controller.

In the method for controlling, regulating, diagnosing, and/or monitoring a component of compressed-air generation that is provided according to the invention, it may be expediently provided that determining, providing, prediction, or optimizing operational data, operational states, operational modes, operational behavior, and/or operational effects is also performed in the context of diagnosing, and/or controlling, regulating, and/or monitoring. Optimizing in general terms is understood to mean that operational data, operational states, operational modes, operational behavior, and/or operational effects are improved in relation to a situation which was given up to that point in time, without an optimal state which is clearly envisaged having actually (already) been achieved.

It should be pointed out in more general terms that the aspects which have been described as being advantageous may require both a refinement of the electronic control device as well as a refinement of the method, and that advantageous aspects which have been described in the context of the control device to this extent may also be applied to the method and vice-versa, respectively.

In a likewise preferred design embodiment of the method by means of the models also operational data, operational states, and or state quantities of the components, for which the measured values/sensor values are not or not yet available, are carried over and/or deduced in the evaluation process. In particular, the method according to the invention may also refer back to so-called virtual sensors, that is to say to operational data, operational states, state quantities, which would potentially be physically measurable but the factors of which are not physically detected but rather deduced by means of one or a plurality of models.

In one further preferred design embodiment, simulations by calculating or estimating the temporal development of operational data, operational states, and/or state quantities of the components, in particular by the numerical integration over time of model equations, are (also) carried out in the evaluation process.

It may furthermore be provided in the method according to the invention that the results of the evaluations carried out by one or a plurality of models are used for initializing and/or as predefined determining factors for evaluations with further models.

According to one non-mandatory potential aspect of the present method, the evaluation process is carried out during operation of the component. In particular, the evaluation process may also be carried out so as to be simultaneous with an operation of the component; in particular, there may be direct interaction between the operation of the component and the evaluation. In one potential design embodiment of the present method the evaluation process for a certain operational behavior of the component is carried out by means of a component model so as to be temporally prior to said operational behavior, or during said operational behavior, or subsequent to said operational behavior. The evaluation process may thus take place prior to the operational behavior, at the same time as the operational behavior, or thereafter.

In one non-mandatory potential design embodiment it is provided that the operational data, operational states, and/or state quantities of the components, which are used and/or deduced when carrying out the evaluations, for which sensor values are not or not yet available, comprise
the state of servicing, of wear, or of aging of the component,
state quantities for which current values are not measurable or measurable only in a limited manner, and/or of which the values depend on the entire temporal profile of the operation of the components since the last service or refurbishment, or
state quantities which are only detectable, in particular measurable, in an inaccurate, cost-intensive, and/or error-prone manner.

It may furthermore be provided that configuring the type, the number, the sequence, and/or the scenarios of the evaluations comprises simultaneously or sequentially carrying out a plurality of evaluations for alternative future profiles of predefined determining factors, in particular of control commands for changing the operational mode or the operational state, and in that a selection of the most favorable profiles of predefined determining factors is performed as a consequence of an appraisal of the evaluation results.

In one potential design embodiment appraising the evaluation results and selecting the most favorable future profiles of predefined determining factors is performed while employing at least one target function which contains one or more of the following criteria for the simulation horizon:
energy consumption, energy costs,
maximum value of electrical power input,
number of changes of the operational state,
utilizable amount of waste heat, and/or temperature level of the waste heat,
utilizable amount of waste heat, and/or temperature level of the waste heat,
proportional servicing costs caused in the simulation horizon.

With a view to identifying and diagnosing malfunctions or defects it may be advantageous that temporal profiles of operational data, of operational states, and/or of state quantities of the component that have been obtained from evaluations of past time periods or are otherwise predefined, in particular calculated, are compared with real current or historical measured values/sensor values, wherein deviations between evaluation results and measured values/sensor values are used for identifying and diagnosing malfunctions or defects. Combined therewith or independently therefrom, it may furthermore be provided for diagnosing malfunctions and defects that alternative evaluations with configurations of models that contain variable potential malfunctions or defects are carried out, wherein in a comparison step for identifying the most likely malfunction or the most likely defect, respectively, the respective degree of similarity between alternative evaluation results and real, current or historical measured vales/sensor values are drafted, or at least less likely or unlikely error sources (malfunctions and defects), respectively, are excluded as a result of the comparison step, respectively.

Instead of the propagated comparison between a plurality of alternative evaluations, where necessary also additionally to the propagated comparison between a plurality of alternative evaluations, in the case of only one model-based profile assuming the presence of a malfunction or of a defect, respectively, for comparison with the real operational profile, where necessary a conclusion pertaining to the presence of a defect or a malfunction may also be drawn using a qualitative or quantitative indication of the probability of the presence of a malfunction.

Finally, it may also be provided that in order for malfunctions or defects to be identified, plausibility criteria for real measured values/sensor values are deduced from structural models, and the adherence of real, current or historical measured values/sensor values to these plausibility criteria is checked.

It is provided in one preferred design embodiment that the evaluations are carried out on demand by a superordinate electronic controller. To this extent it is possible in particular that the superordinate electronic controller issues the demand and/or also carries out the evaluation. An exemplary sequence may be as follows:
Step 1: the superordinate controller issues a demand for an evaluation (evaluation demand);
Step 2: the evaluation is carried out by the component controller;

### Optional

Step 3: the evaluation result is used by the component controller and/or transferred to the superordinate controller.

The invention will be discussed in more detail hereunder by means of the description of exemplary embodiments and with reference to the appended drawings, also in terms of further features and advantages. In the drawings:

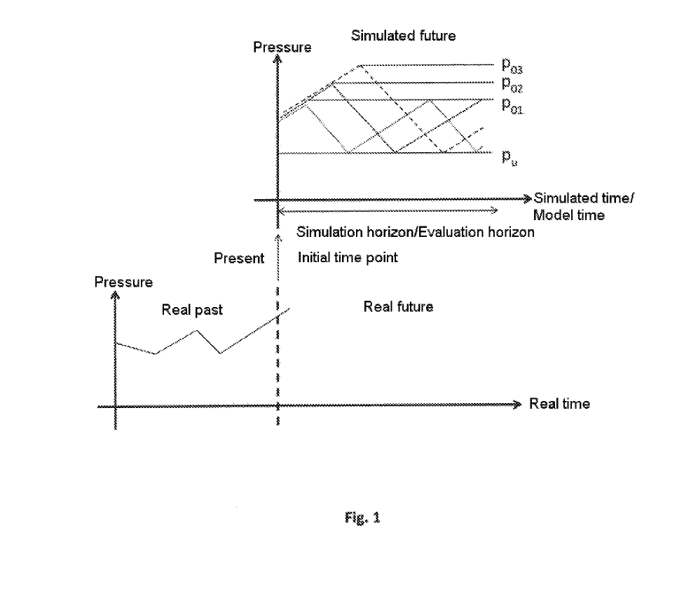

FIG. 1 shows a diagram visualizing the principle of pre-simulation by means of an exemplary embodiment;

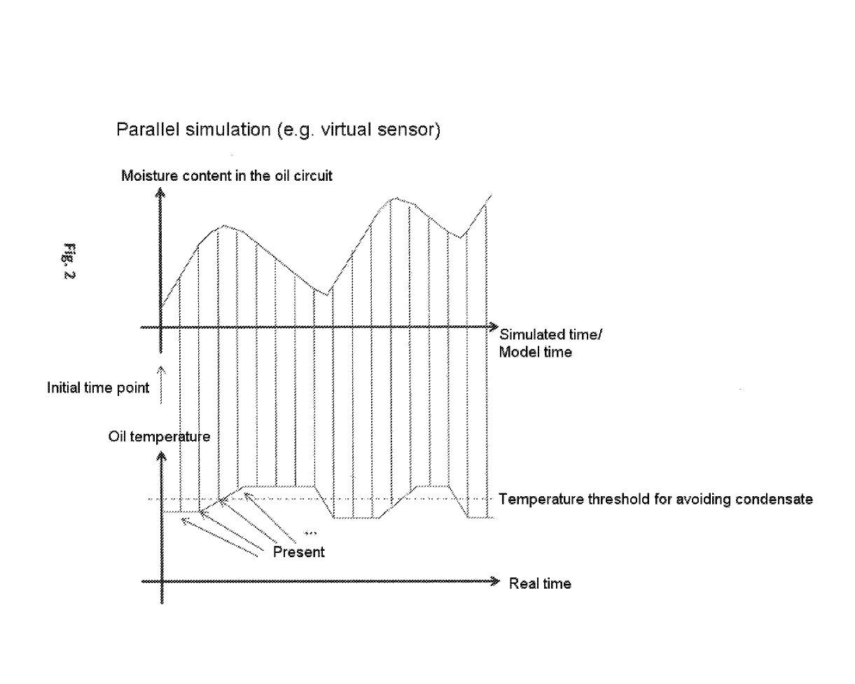

FIG. 2 shows a diagram visualizing the principle of parallel simulation by means of a second exemplary embodiment;

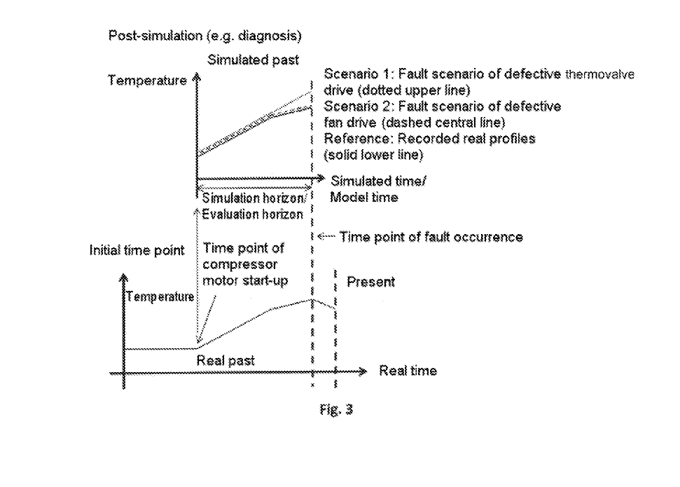

FIG. 3 shows a diagram visualizing the principle of post-simulation by means of a third exemplary embodiment;

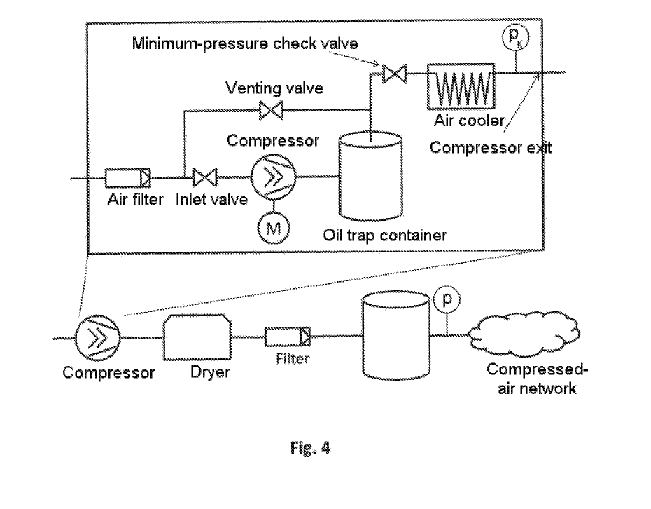

FIG. 4 shows the structure and incorporation of a component according to the present invention, here specifically of a stationary, oil-injected screw compressor;

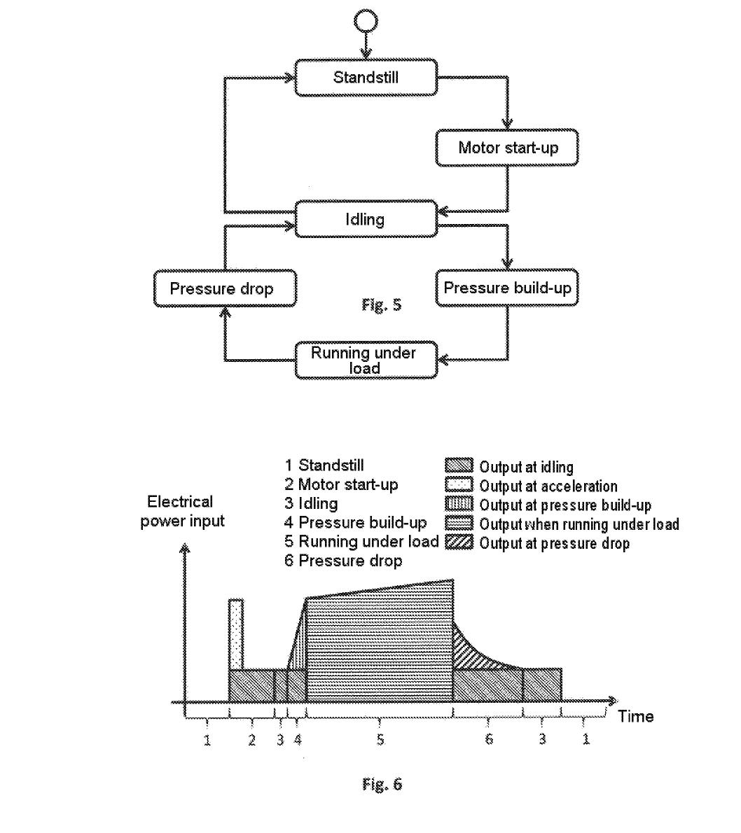

FIG. 5 shows a diagram visualizing the various operational states of a stationary, oil-injected screw compressor (state of the art);

FIG. 6 shows a diagram visualizing in a model-based manner the temporal profile of the electrical power input of a screw compressor;

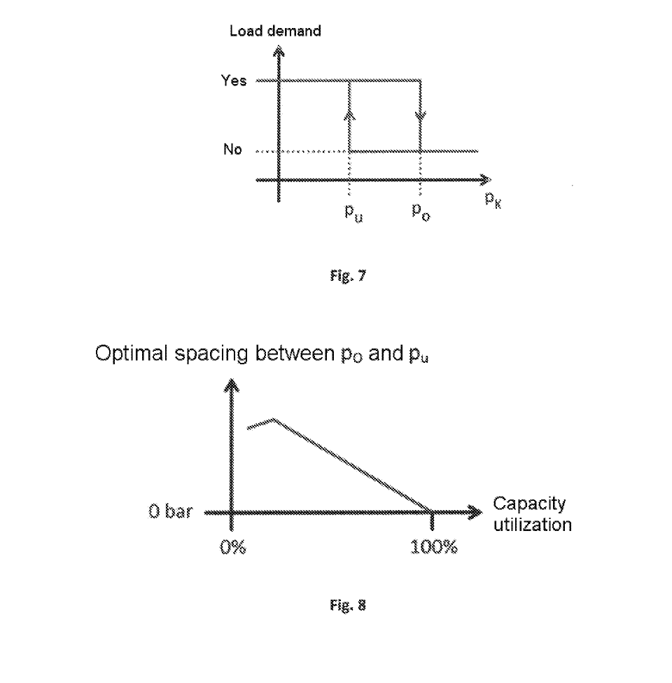

FIG. 7 shows a visualization of actuating a stationary, oil-injected screw compressor (state of the art);

FIG. 8 shows a diagram visualizing the in-principle correlation between capacity utilization and optimal spacing between pₒ and pᵤ;

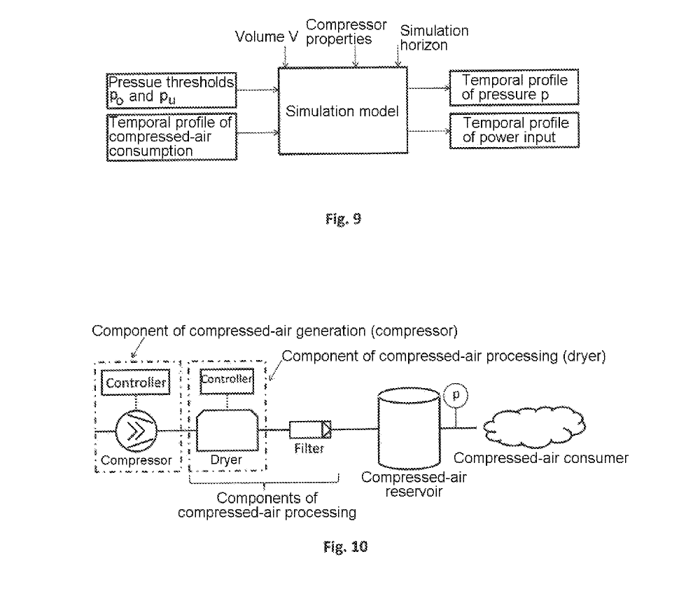

FIG. 9 shows an embodiment of a simulation model;

FIGS. 10-13 show various potential exemplary embodiments for processing a structural model, in particular a simulation model, in a control device;

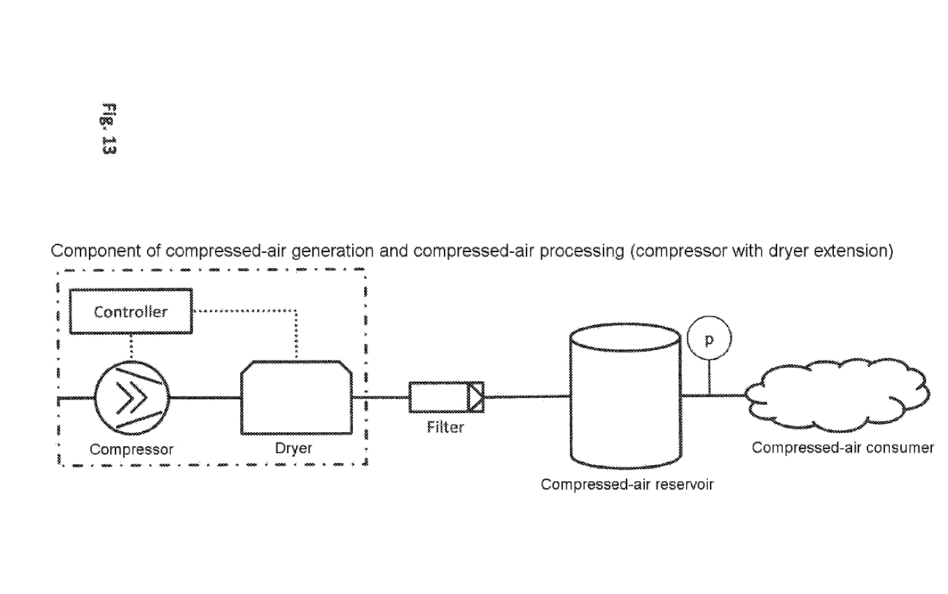

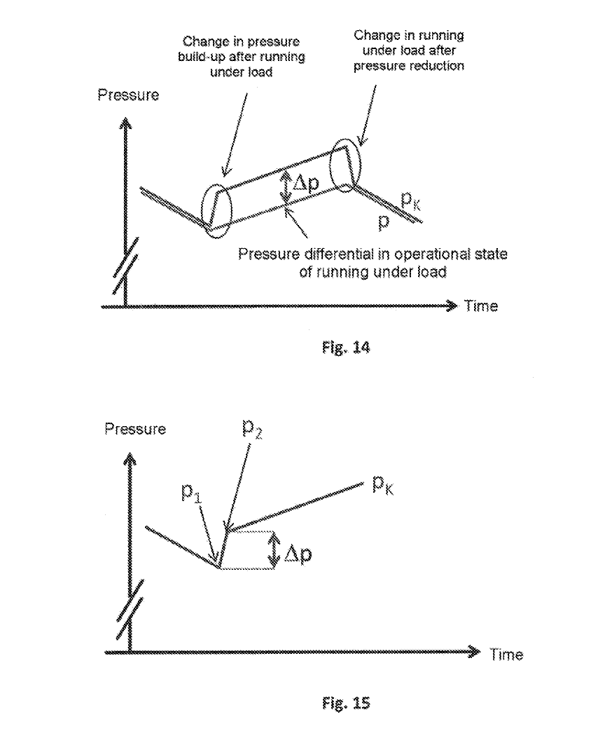

FIG. 14 shows a diagram visualizing pressure differentials in the change in pressure build-up after running under load, and during the change from running under load after pressure reduction;

FIG. 15 shows an approximation of the circumstances visualized in FIG. 14, in a model-based manner;

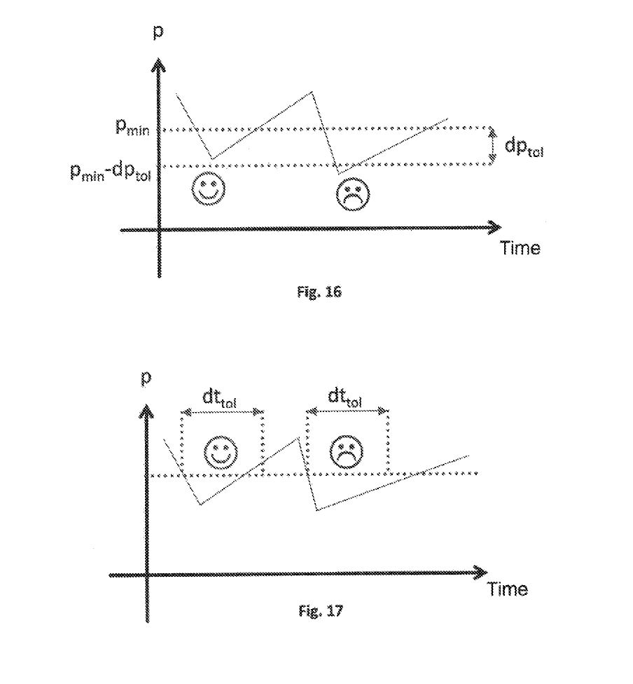

FIGS. 16-18 shows various approaches by way of which undershooting of a lower pressure limit pₘᵢₙ may be gauged or categorized, respectively;

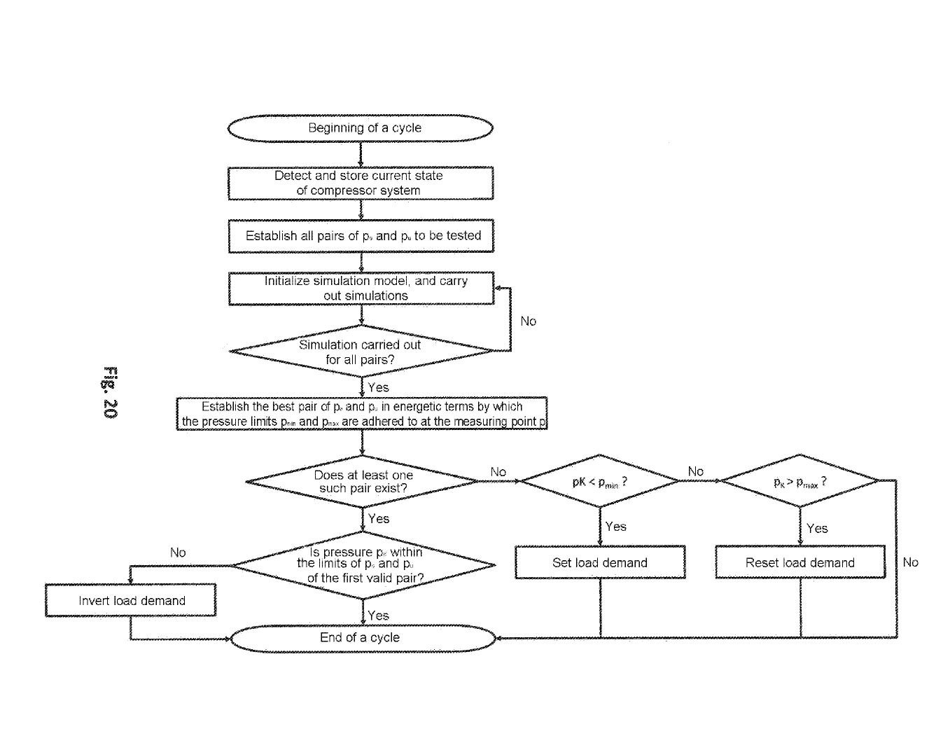

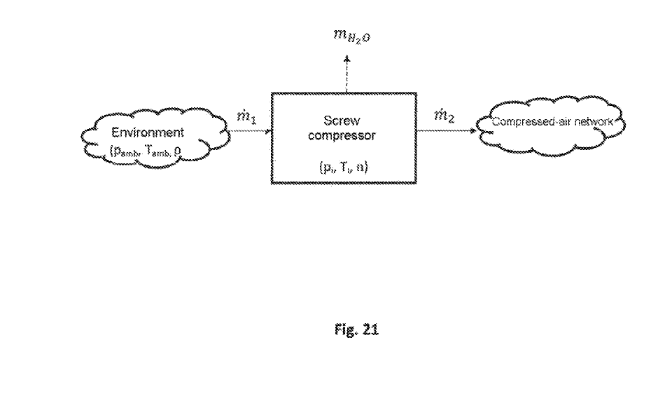

FIG. 19 shows the visualization of a sliding controller for establishing an individual compromise between energy efficiency and adherence to a pressure limit;

FIG. 20 shows a flow diagram visualizing an exemplary embodiment of the present invention, in which an algorithm cycle applied;

FIG. 21 shows a visualization of an embodiment of a model according to the present invention;

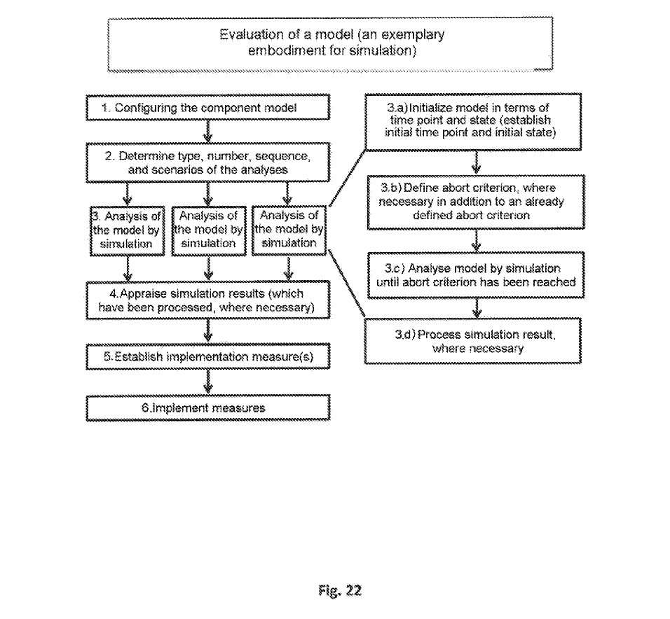

FIG. 22 shows a visualization of an exemplary embodiment of a simulation model;

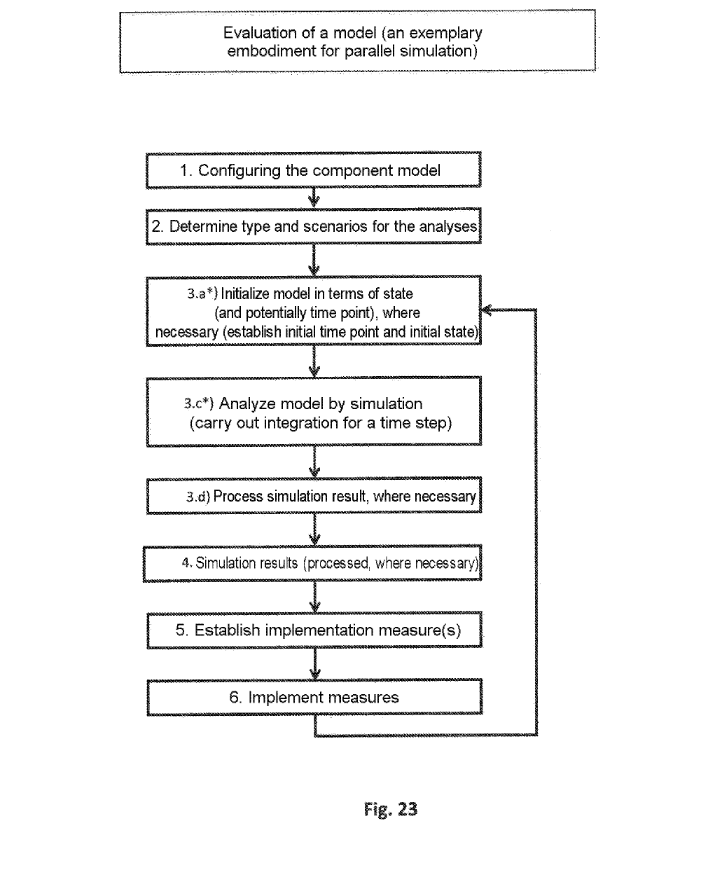

FIG. 23 shows a visualization of an exemplary embodiment of a parallel simulation model.

It is now to be stated in even more detail hereunder what is to be understood as a component, and what applications are conceivable, respectively, when evaluations are performed on the basis of a model in the case of a component of compressed-air generation, compressed-air processing, compressed-air storage, and/or compressed-air distribution.

In general terms, a model is indeed to be understood as the simplification or the simplified depiction of a system, respectively, here specifically of a component of compressed-air generation, compressed-air processing, compressed-air storage, and/or compressed-air distribution.

1. Properties of a model of a component in general
a) Simplification means that the model in many properties/aspects does not conform to the component to be evaluated. A model which in all properties/aspects conforms to the component to be evaluated is not a model of the component, but is the component to be evaluated per se.
b) A model allows operational data, operational states, operational modes, operational behaviors, and/or operational effects of a component to be evaluated without reference having to be made back to the component per se for this analysis. It is essential here that the properties/aspects of the component to be evaluated that are relevant to the respective evaluation are depicted with sufficient accuracy in the respective model.
c) Since a model always represent a simplification of the component to be evaluated, there cannot be “the one model” of a component. There will always be a plurality of models or part-models for one component, respectively. Which model is to be drafted for any evaluation depends on the evaluation task (question asked). It may be here that the same model may be used for various evaluation tasks. In this way, a plurality of models may be compiled for a stationary, oil-injected screw compressor:
c.1. model of the oil circuit
c.2. model of the air circuit
c.3. thermal model of the compressor motor
c.4. model of the operational state
c.5. . . .

A plurality of the aspects mentioned above may also be considered in one model.

All these models describe various properties/aspects of a stationary, oil-injected screw compressor. None of the models describes all properties/aspects of a stationary, oil-injected screw compressor (otherwise said model would not be a model but a stationary, oil-injected screw compressor). Accordingly, different models have to be chosen for various evaluations.

2. Models process dissimilar variables in different ways

Models may also be differentiated by the types of the effects which are described by a model.
a) Physical models: For models to be employed in a component controller it is obvious that models describe physical effects which arise during operation of the components. Examples may be:
a.1. Controlling in real time: Multiple applications of a simulation model of the component in order to determine quasi-optimal control actions for optimal operation of the component in relation to one or a plurality of physical effects. →Pre-simulation model.
a.2. Monitoring: Continuous execution of a simulation model of the component in order for the expected profile of measured values to be compared with the real observed profile of measured values. If the expected (model) behavior and the real observed behavior seriously diverge, conclusions may be drawn therefrom to an erroneous behavior of the component. Parallel simulation model.
a.3. Diagnosing: Multiple application of a simulation model of the component in order to determine which error of a component that is capable of being simulated in the model best conforms to the profiles of measured values that have been recorded using the real component prior to the occurrence of an error. →Post-simulation model.
a.4. Virtual sensors: In many cases it is not possible for technical or economic reasons, or at least not worthwhile, for measured values which, for example, may advantageously be used for controlling to be detected in the machine. By applying a simulation model of the component that is continually balanced with the real behavior of the component it is possible for such measured values to be determined. →>Likewise a parallel simulation model.
b) Monetary models: Physical effects in the component are of only indirect interest to the operator of a component (and usually only when there is some issue with the component). Models which process monetary variables are of immediate interest. The following applications are conceivable for this type of models, for example:
b.1 Calculating energy costs: The energy costs for operating the component may be calculated by way of a model for the costs for electrical energy (electricity tariff model) from the temporal profile of the behavior of the component (recorded in the past or calculated by pre-simulation), and from the electrical power input therein.
b.2. Calculating servicing costs: The servicing costs may be calculated from the temporal profile of the behavior of the component (recorded in the past or calculated by pre-simulation) while applying a servicing model.
b.2.1. In a simple variant the servicing costs are calculated based on the operating hours of the component.
b.2.2. In a more complex variant the servicing costs are calculated based on wear models of the service parts (the former consider the conditions of the physical environment under which the component is operated).
b.2.3. Things become truly interesting (but also highly complex) when simultaneous servicing of a plurality of components (and thus savings in travel costs) is considered in the case of linked machines.
b.3 Optimal operation of the component in terms of total cost: In the context of cost optimizing it would be interesting to control and service the component such that the total costs of the component are minimized. It may be imagined that degrees of freedom which allow low-wearing or energy-efficient operation exist for the controller in a component. In the case of stationary, oil-injected screw compressors having a heat-recovery system (WRG), the VET (VET=final compressor temperature) could be such a degree of freedom, for example. The higher the VET, the higher the potential heat exploitation by WRG. The higher the VET, the faster the wear on oil, for example. Cost-optimized VET may be calculated by offsetting WRG gains against oil servicing costs.
c) Appraised models: Appraised models may be used in order for servicing costs to be minimized. Appraised models are understood to be models which in one way or another contain subjective appraisals of physical or monetary variables (appraised sound pressure is the archetype here). Examples of appraised models are wear models for components or for consumables.
c.1. Example of the air filter in the case of stationary, oil-injected screw compressors:
c.1.1. Primitive variant: The degree of wear of the air filter is calculated in a simple manner based on the operating hours of the compressor. A filter change is due once a threshold value of the operating hours has been reached.
c.1.2. Somewhat more complex variant: The degree of wear of a filter is indicated in relation to volumetric flow and differential pressure in a performance map. The performance map is determined empirically.
c.2. Example of oil in the case of stationary, oil-injected screw compressors:
c.2.1. Primitive variant: The degree of wear of the oil is calculated in a simple manner based on the operating hours of the compressor. An oil change is due once a threshold value of the operating hours has been reached.
c.2.2. Complex variant: The wear of the oil is calculated depending on VET, for example as an integral of VET over time. An oil change is due once the area of VET over time exceeds a predefined threshold value.
d) Logical models depict the behavior of control algorithms (“control-technology pendant to physical models”).
e) Stochastic models depict facts which cannot be described in a deterministic manner.

3. Models describe dissimilar facts

Models may also be differentiated by what is described by the model.
a) A model may describe information pertaining to the structure of a component. In this way, an Piping and instrumentation diagram may describe which part-components a component is composed of and how the part-components are interconnected in the component. Which part-components a component is composed of may still be determined from a bill of materials of a component. To this end, reference may be made to an piping and instrumentation diagram and/or a bill of materials, in order for a model to be compiled. Models which contain structural information are well suited to being primary models. New models may be derived from primary models by applying analytic algorithms.
b) A model may describe items of information pertaining to the behavior of a component.
b.1. Static models describe the behavior of a component at a given operational point, while ignoring transient procedures which describe how the component has reached the operational point. Static models are in many cases directly accessible in an appraisal (question being, for example, the operation point having best specific output?)
b.2. Dynamic models describe the behavior of the component over time (transient behavior). These models supply profiles of measured values that are not directly accessible for an appraisal. The profiles of the measured values first have to be converted to key figures prior to any appraisal being possible (by means of the key figures).

4. Applying models

Models may be applied/executed in various manners in a controller of a component. How a model is applied/executed also depends on the type of the model.
a) Models may be used in order for new models to be derived. Models having structural information (Piping and instrumentation diagrams, for example) in particular are candidates for models from which new models are derived. Deriving is performed in that the preliminary model is interpreted by an analytic algorithm and the latter, using knowledge stored therein, generates a new model.
b) Models may be used for replicating the behavior of a component. The model here is used as a simulation model in order for a future potential behavior, or a behavior which has been observed in the past, of the component to be calculated as a temporal profile. It is decided by way of an algorithm core which simulations are to be carried out with the simulation model, and how the simulation results are to be interpreted.
c) Models may also be used directly for optimizing. To this end, an optimizing method which is able to directly analyze the model in terms of a given question must exist for the type of the model. An example of such models are simple characteristic curves (for example, specific output over utilization).
d) A combined application of models is particularly interesting.
d.1. A simulation model of the component is derived from an Piping and instrumentation diagram of the component (starting model).
d.2. How the component is operated under given parameters is determined by means of the pre-simulation model. The temporal profile of measured values in the component is the result of the pre-simulation.
d.3. The servicing costs for operation over the coming months are determined by means of the temporal profile of measured values of the component, that have been determined by pre-simulation, while applying wear models for servicing parts.

5. Three application scenarios for models (behavior models)
a) Pre-simulation

In the case of a stationary, oil-injected screw compressor having a star-delta start-up the pressure at the compressor exit is to be maintained above 6.5 bar and below 8 bar. Proceeding from the current state of the compressor and the pressure in the vessel, while assuming a constant consumption profile of compressed air, it is determined by applying a model (simulation model) at which upper shut-off pressure the best specific output results. To this end, various alternatives are reviewed, cf. FIG. 1. The simulation results are then used (and meaningfully also only then determined) when the compressor is under load:
if the current pressure is below the shut-off pressure with the best specific output, the compressor remains under load;
if the current pressure is above the shut-off pressure with the best specific output, the compressor is relieved of load.

Questions to be answered:
What is the initial time point? Present
What is the initial value of the state quantities? The real state of the compressor (for example, compressor under load, internal pressure 7.2 bar; compressor motor switch-on time 403 seconds; pressure in the vessel 7.0 bar=pressure at the compressor exit)
Which simulation period is evaluated? 10 minutes (arbitrary establishment)→complete simulation horizon
Which temporal profiles of the input values are imprinted? Constant compressed-air consumption (for example, determined from pressure gradients in the past)
Which model parameters are used?
   (Effective) volume of the compressed-air reservoir
   Delivered amount of the compressor (predefined by the user as a characteristic value)
   Output under load and when idling, predefined by the user as characteristic values
b) Parallel simulation (or “conjointly running simulation”)

The moisture content of the oil is to be estimated in the case of a stationary, oil-injected screw compressor. To this end, a model of the combined oil/air circuit is used. The model is executed in a conjointly running manner, that is to say that real time and simulation time run in a synchronous manner, cf. FIG. 2. The simulation model is started once and then initially runs so as to be unlimited.

Questions to be answered:
What is the initial time point? Time point at which the controller commences operation.
What is the initial value of the state quantities? The water mass in the oil circuit is 10% of the oil mass in the oil circuit (arbitrary establishment, conservatively considered: the compressor has not been run dry during its last operation)
Which simulation period is evaluated? The evaluated simulation period commences at that time point at which the controller commences operation, and ends when the controller ends operation (termination of voltage supply)
Which temporal profiles of the input variables are to be imprinted?
   Current induction temperature
   Current internal pressure
   Current VET
   Current compressor rpm
Which model parameters are to be used?
   Oil volume in the oil circuit
   Relative humidity of the inducted air

To this extent it is also proposed according to a non-mandatory aspect of the present invention that the moisture content in the oil is determined while applying a simulation model.

A model for estimating the moisture content in the oil in the case of a stationary, oil-injected screw compressor is to be discussed in more detail hereunder: Here, a design embodiment of the screw compressor in which an electric control valve is incorporated in the oil circuit is assumed. The electric control valve enables the controller to influence the cooling output of the system. The objective of this influence is to avoid the formation of condensation in the screw compressor, to accelerate the evacuation of condensate, and to not maintain the temperature level in the oil circuit at an unnecessarily high level.

The pressure variables used in the model are to be understood as absolute pressure. At points where positive pressure in relation to the environment is used, this is identified by explicitly forming a pressure differential. The temperatures used in the equations are absolute temperatures (unit: “Kelvin”).

In relation to the true process (screw compressor), drastic simplifications have been performed while modelling:
The volumetric air flow flowing into the screw compressor is equal to the outflowing volumetric air flow (in relation to the ambient conditions).
The water content of the oil circuit varies only in the operational state under load.
The mass flow of water flowing out of the screw compressor depends exclusively on the internal pressure and on the internal temperature.
The dependency on the water content of the oil circuit (in the case of water being present) or of the circulating amount of oil (between the oil trap container and the compressor block) is ignored.

It goes without saying that modified models which do not perform the simplifications mentioned above may also be used.

A monolithic model of the screw compressor is established in order for the water content of the oil circuit to be determined in oil-injected screw compressors. The model depicts the oil circuit of an oil-injected screw compressor in a highly simplified manner. The model serves for estimating the water mass in the oil circuit that is not measurable due to the absence of sensors. To this end, the water flows at the system limits (environment and compressed-air network) that are likewise not measurable, are estimated by means of measured variables. By accounting for the water flows at the system limits, and assuming a certain initial content of water in the oil circuit, the water content may be determined in this way. Only effects which are unconditionally necessary for estimating the water content are considered. FIG. 21 shows the structure of the model:

The screw compressor forms the core of the model. Accounting for the water flows takes place in the screw compressor. To this end, the water mass \dot{m}₁ which flows from the environment into the screw compressor is offset against the water mass \dot{m}₂ which flows out of the screw compressor into the compressed-air network. The change in the water mass \dot{m}_{H}_{₂}_{O} which is stored in the oil circuit is formed by the difference (see formula 1).

$$\frac{d {m}_{{H}_{2} O}}{d t} = {\dot{m}}_{1} - {\dot{m}}_{2} \qquad Formula 1$$

The water mass \dot{m}₁ which flows from the environment into the screw compressor is determined from the inducted volumetric air flow \dot{V}₁. The inducted volumetric air flow depends on the revolutions n of the compressor and on the pressure differential between the induction side and the high-pressure side of the screw block. It is assumed in a simplifying manner that the pressure differential is able to be determined by measuring the internal pressure p₁ of the compressor and the pressure p_{amb} of the environment (see formula 2). The precise correlation between the volumetric flow, the revolutions, and the pressure differential is specific to the compressor and is approximated by way of a characteristic curve which may be determined in the context of measurements on prototype systems, for example.

\dot{V}₁=f(n,pᵢ−p_{amb}) Formula 2

In order for the flow of inducted water mass to be calculated, the volumetric air flow is offset against relative humidity ρ and the induction temperature T_{amb}, applying the Clausius-Clapeyron equation and assuming a constant specific evaporation heat for water, (see formula 3).

$${\dot{m}}_{1} = ρ * \frac{{E}_{s} ( 273.15 K ) * {e}^{( \frac{{q}_{c}}{{R}_{w}} * ( \frac{1}{273.15 K} - \frac{1}{{T}_{amb}} ) )}}{{R}_{w} * {T}_{amb}} * {\dot{V}}_{1} \qquad Formula 3$$

The formula is valid for environmental temperatures between 0° C. and 100° C. The variables used have the following meaning:
E_{S}(273.15 K)=6.1mbar: steam pressure at 0° C. (273.15 K)

$${q}_{c} = 2410 \frac{kJ}{kg} \text{:}$$

specific evaporation temperature of water

$${R}_{w} = 0.462 \frac{kJ}{kg * K} \text{:}$$

specific gas constant of water.

The outflowing water mass \dot{m}₂ is determined by means of the maximum absorbability of the volumetric air flow \dot{V}₂ which flows from the screw compressor into the compressed-air network. It applies here (as a simplifying assumption in this model) that the outflowing volumetric air flow (in relation to the environmental conditions) is equal to the inflowing volumetric air flow (in relation to the environmental conditions) (see formula 4).

$${\dot{V}}_{2} = \frac{{p}_{amb}}{{p}_{i}} * {\dot{V}}_{1} \qquad Formula 4$$

First, the mass flow of water \dot{m}_{100%} is formed, while assuming a relative air humidity of 100% at the temperature in the oil trap container Tᵢ (see formula 5). Formula 5 is based on the same physical principles as formula 3.

$${\dot{m}}_{100 \%} = \frac{{E}_{s} ( 273.15 K ) * {e}^{( \frac{{q}_{c}}{{R}_{w}} * ( \frac{1}{273.15 K} - \frac{1}{{T}_{1}} ) )}}{{R}_{w} * {T}_{i}} * {\dot{V}}_{2} \qquad Formula 5$$

The flow of water mass \dot{m}_{100%} represents only an auxiliary variable and not the actual flow of water mass from the screw compressor. This is because it has not been considered in the calculation whether water is currently being introduced into the screw compressor (\dot{m}₁>0) or whether water is present in the oil circuit (m_{H}_{₂}_{O}>0). Water that is not present cannot be discharged from the screw compressor. Therefore, a correction has to be performed for the calculation, where necessary (see formula 6). Formula 6 ensures that there is never less than “no” water in the oil circuit.

$${\dot{m}}_{2} = \{ \begin{matrix}{\dot{m}}_{1} , & wenn {\dot{m}}_{100 \%} > {\dot{m}}_{1} und {m}_{{H}_{2} O} = 0 \\ {\dot{m}}_{100 \%} , & sonst\end{matrix} \qquad Formula 6$$

The model presented above requires prior knowledge of variables which are not (able to be) measured in the case of every type of compressor. These variables either have to be calculated from other measured variables or be simply predefined. It will be discussed hereunder how the value for some of the variables could be determined or established, respectively.

It is most often not provided that the relative humidity of air of the inducted environmental air is measured. The relative humidity of air should be predefined as a constant. In the context of an interpretation of the worst-case scenario of the virtual water content sensor, a value of 100% could be established for relative air humidity. Alternatively, it is conceivable for the value to be made parameterizable by way of the menu.

The revolutions of the compressor block may be assumed to be proportional to the revolutions of the motor. In the case of screw compressors having frequency inverters (FU) the revolutions of the motor over running time may be read from the FU. In the case of compressors without an FU the motor revolutions have to be estimated. A simple estimation would be by pre-defining the motor revolutions or the revolutions of the compressor block, respectively, by way of a control parameter. The network frequency (50 Hz or 60 Hz), the number of pole pairs of the motor, and a gearing ratio (in the case of systems having a belt drive) are to be considered here.

Not every screw compressor has a sensor for measuring the internal pressure pᵢ in the compressor (pressure in the oil trap container). In the case where pᵢ cannot be directly measured, the network pressure p_{N} (which is always measured) may be used as an approximation. Here, P_{N} is corrected by a premium for the pressure reduction by way of the air cooler Δ_{N} (0.5 bar, for example). The corrective summand Δ_{N} depends on the type of compressor and may be set by way of a control parameter.

In the case of there being no sensor present for detecting the temperature Tᵢ in the oil trap container, the final compressor temperature T_{ADT} provided with a discount ΔT (5 K, for example) is used to estimate Tᵢ. The temperature discount ΔT depends on the type of compressor and may be set by way of a menu parameter.

A further exemplary application is a parallel simulation for the purpose of monitoring:

A conjointly running simulation model is supplied with determining factors (for example, the current operational state and state change, environmental temperature, network pressure) and generates further state quantities. The latter include those for which real measured values exist, and those for which real measured values are absent.

The available real measured values are compared with the respective values of the simulation model. The deviation between the two, when certain threshold values are exceeded, leads to alarm or error messages, optionally also to the components being shut down, depending on a preliminary setting, a predefined value, or gauging.

On account thereof, reaction may be made in a non-specific manner to deviations from the “normal” behavior, (that is to say from the undisturbed model, for example), this deviation potentially being the result of error for which no defined evaluation rule pertaining to one or a plurality of sensor signals exists, for example because the evaluation rule is not known, or because the required sensors do not exist in the component.

Exemplary application: On account of contamination, the differential pressure of a filter increases to an impermissible range. There is no differential-pressure switch or differential-pressure sensor for the filter. However, the increasing differential pressure leads to increased power input and/or to an increased temperature by way of an increased internal back pressure, wherein there are occasionally sensor values for these variables, which may be compared to the values of the simulation model. Errors at the one point may be identified by comparing sensor and model values at another point. This may be in a specific manner (increased power input may mean contamination of the filter or filters . . . ) or in a non-specific manner (“meaning not clear, but represents an unexpected anomaly; better to shut off the component and to carry out manual, automatic, or semi-automatic fault diagnosis”).

A reaction may occur to every imprint of a “non-plausible” behavior of a component, without a specific imprint of a precisely defined error having to be known and having to have been converted to a monitoring function.

c) Post-Simulation

In a stationary, oil-injected screw compressor, VET-monitoring has been triggered after the start-up of the compressor motor, that is to say that VET-monitoring has recognized that the VET (final compressor temperature) has exceeded a previously parameterized threshold value of 110° C., for example. The cause of VET-monitoring having been triggered is to be determined by means of post-simulation. Two potential causes are known:
The drive of the electric control valve has failed.
The fan motor has failed.

In order for the job of the operator or service personnel to be facilitated it is to be checked automatically whether one of the two above-mentioned causes, and which one thereof, is relevant in the present case.

The post-simulation model replicates the oil/air circuit of the compressor. For diagnosing, the post-simulation model is initialized with the state prior to the start-up of the compressor motor, as observed in real terms in the compressor. Proceeding from this initial state (beginning state), the post-simulation determines the profile of VET over time. By way of a parameter the post-simulation model may be tasked with mirroring the behavior in the case of a failed drive or a failed fan motor. Two different alternative profiles are thus post-simulated in the present example. In the first post-simulation the model is configured such that the behavior of the combined oil/air circuit is mirrored in the case of a defective electric drive of the thermovalve (drive at standstill). In the second evaluation the model is configured such that it mirrors the behavior of the combined oil/air circuit in the case of a defective fan motor (fan motor at standstill).

As is illustrated in the figure, two different temporal profiles of VET result from the evaluation of the model in FIG. 3 in the two different configurations. Now comparing the recorded real profile of VET (solid black line) with the profile of VET as determined by evaluating the model in the case of a defective valve drive (scenario 1) and the profile of VET in the case of a defective fan drive (scenario 2) which has likewise been determined by evaluating the model, it is established that the VET profile in the case of a defective drive of the thermovalve better conforms to the real observed profile of VET than is the case with a defective fan drive. It can be concluded therefrom that, if at all, only a defective drive of the thermovalve may be considered as one of the two known error causes.

d) General considerations pertaining to simulations

Post-Simulation:
Post-simulation need not be carried out immediately once the error to be analyzed arises.
Post-simulation may begin in the past and end in the past.
The beginning in the past is linked to an event which is relevant to the analysis (start-up of the compressor motor, for example).
Alternative pasts may be calculated in the case of post-simulation. Thus, simulated behavior and real observed behavior may be compared with one another. Comparing may comprise a comparison between simulated behavior and real observed behavior. Preferably, however, comparing also comprises the comparison of alternative simulated behaviors with the real observed behavior.
The initial time point in the case of post-simulation relates to the past.

Parallel Simulation:
Real time and simulated time run in a synchronous manner→same speed.
Initializing typically is performed once when the controller starts up (or optionally there is re-initializing in the case of certain events).
Evaluating typically continues as long as the controller is running.

Pre-Simulation:
A potential future is calculated in the case of pre-simulation. There is nothing equivalent to this in reality (since the real future has not yet occurred).
The initial time point in the case of pre-simulation relates to the real present.

In General:
Simulation is always carried out in the present.
In the case of pre-simulation and post-simulation, real time and simulated time (in relation to real time) run at different speeds. The simulated time (in relation to real time) runs at a significantly faster speed. This is inevitable in the case of pre-simulation. In the case of post-simulation, this will typically likewise be the case, not least on account of the high computing performance which is available nowadays. However it is also possible here for the simulated time to run more slowly or so as to correspond to the post-simulated period of time.

6. “Component of compressed-air generation, compressed-air processing, compressed-air storage, and/or compressed-air distribution”, and assignment/arrangement of the respective controller(s) of the component(s)

A few further exemplary embodiments in which the models of the components are directly drafted for improved controlling of the component are to be illustrated hereunder. The underlying component to be controlled is a stationary, oil-injected screw compressor which by way of components of compressed-air processing (here a filter and a dryer) conveys compressed air into a compressed-air reservoir by way of which a compressed-air network is supplied with compressed air. The resulting structure of the screw compressor, here underlying the components, is illustrated in FIG. 4.

A screw compressor 11 together with further components, specifically a dryer 12, a filter 13, and a compressed-air reservoir 14, forms respective components of a compressor system which at a transfer point 16 between the compressed-air reservoir 14 and the compressed-air network 15 delivers compressed-air at a certain pressure to a compressed-air network 15. The screw compressor 11, here as a component which is viewed in an exemplary manner, per se has a plurality of mostly integrated part-components, specifically, on the entry side, first an air filter 17, a compressor 19 which is driven by a motor 18, an oil trap container 20, a minimum-pressure check valve 21, an air cooler 22, and a compressor exit 23. The aforementioned part-components, proceeding from a compressor entry 24, are disposed in series in the mentioned sequence. An inlet valve 25 which is assigned to the compressor is also provided between the air filter 17 and the compressor 19. Finally, a bypass line 26, having a venting valve 27 having a breakout 28 upstream of the inlet valve 25 and a connector point 29 downstream of the oil trap container 20, is provided.

The controlling task lies in maintaining the pressure p at the transfer point 16 between the compressed-air reservoir 14 and the compressed-air network 15 above a minimum pressure pₘᵢₙ and below a maximum pressure pₘₐₓ, and to thereby minimize power input to the component (of the screw compressor 11). As has already been mentioned, there are also components of compressed-air processing between the exit of the component 11 and the compressed-air reservoir 14, which components cause pressure reduction which has the effect of increasing the power input to the components (of the screw compressor).

The in-principle mode of functioning of a stationary, oil-injected screw compressor may be described by way of the operational states which are visualized in FIG. 5. The following description applies in particular to stationary, oil-injected screw compressors having a star-delta start-up. The description possibly applies to stationary, oil-injected screw compressors having a frequency inverter only to a limited extent.

In the operational state “standstill” the compressor drive is at a standstill, the inlet valve is closed, the venting valve is open, and the oil trap container is pressure-less, the minimum-pressure check valve therefore being closed. The screw compressor has no input of electric power and does not supply any compressed air.

By way of the operational state “motor start-up” the screw compressor may be converted to the operational state “idling”. The compressor drive is started up and brought to operating revolutions in the operational state “motor start-up”. The inlet valve remains closed and the venting valve remains open. The compressed air generated by the rotating compressor is conveyed in a circular manner, by way of a small bore in the inlet valve via the oil trap container and the venting valve. On account of the dimensioning of the bore in the inlet valve and of the cross section of the venting valve, a pressure of approx. 1.5 bar is built up in the oil trap container in the operational state “motor start-up”. Since the minimum pressure check valve only opens at approx. 4 bar, no compressed air is discharged to the compressed-air network; however, the screw compressor does have electrical power input. The operational state “motor start-up” typically lasts 4 s to 10 s. Thereafter the screw compressor is in the operational state “idling”.

The valve positions in the operational state “idling” are identical to those in the operational state “motor start-up”. The compressor drive also continues to rotate in an unvaried manner. The pressure in the oil trap container remains at approx. 1.5 bar. The operational state “idling” is necessary since the compressor drive must only be started-up 4 times to 15 times per hour (due to thermal stress on the motor windings on account of the starting current). In order to be able to generate compressed air on demand at any time, the screw compressor remains in the operational state “idling” until, following a shut-off of the compressor drive (change in the operational state “standstill”), a “motor start-up” following immediately thereupon is possible without exceeding the maximum permissible number of start-ups per hour of the compressor drive. The power input in the operational state “idling” corresponds to approx. 20% to 30% of the power input in the operational state “running under load”.

If there is a demand for compressed air, the operational state “running under load” may be achieved proceeding from the operational state “idling” via the operational state “pressure build-up”. In the operational state “pressure build-up”, the inlet valve is opened and the venting valve is closed. Air is inducted from the environment through the opened inlet valve, said air causing increasing pressure because of the closed venting valve in the oil trap container. As soon as the pressure in the oil trap container exceeds 4 bar and is higher than the pressure downstream of the minimum pressure check valve, the minimum pressure check valve opens. The operational state “running under load” is achieved in this way.

In the operational state “running under load” the inlet valve remains open and the air flows from the screw compressor via the air cooler into the components of compressed-air processing. As long as the demand for generating additional compressed air is upheld, the screw compressor remains in the operational state “load”. If the generation of compressed air is to be terminated, the screw compressor changes via the operational state “pressure reduction” to the operational state “idling”.

In the operational state “pressure reduction” the inlet valve is closed and the venting valve is open. The pressure in the oil trap container is reduced to a pressure of approx. 1.5 bar over a time span of approx. 15 s to 30 s. The screw compressor then is again in the operational state “idling”.

The screw compressor remains in the operational state “idling” until the compressor drive is stopped and may be restarted immediately (→number of permissible motor start-ups) or there is renewed demand for generating compressed air and the screw compressor changes to the operational state “pressure build-up”, so as to achieve the operational state “load”.

The electrical power input of the screw compressor varies between operational states. The electrical power input may be described substantially by the idling output and the output when running under load, which are usually contained in data sheets. FIG. 6 in a stylized form shows the temporal profile of electrical power input depending on the operational state.
In the operational state 1 “standstill” there is no electrical power input to the screw compressor.
In the operational state 2 “motor start-up”, in addition to the idling output, there is the acceleration output for the rotors of the compressor and for the rotor of the asynchronous motor.
In the operational state 3 “idling” there is the idling output. The idling output is typically between 20% and 30% of the output when running under load.
In the operational state 4 “pressure build-up”, in addition to the idling output, there is the pressure build-up output for building up the pressure in the oil trap container.
In the operational state 5 “running under load” there is the output when running under load. The output when running under load depends on the pressure at the exit of the screw compressor and increases as the pressure at the exit of the screw compressor increases (at approx. 6% per bar).
In the operational state 6 “pressure reduction”, in addition to the idling output, there is the pressure reduction output. The pressure reduction output can be traced back to the pressure in the oil trap container, which first has to be reduced before only the idling output remains.

The outputs which arise in the operational states “motor start-up”, “pressure build-up”, and “pressure reduction”, when integrated over time, may be interpreted as acceleration work, pressure build-up work or pressure reduction work, respectively, which arises in addition to the idling work. Expressed as temporal equivalents for operating the compressor at nominal pressure in the operational state “running under load”, the following approximate values result:
Acceleration work: 2 s*output when running under load
Pressure build-up work: 1 s*output when running under load
Pressure reduction work: 3 s*output when running under load

The use of a two-position controller having a hysteresis, as is illustrated in FIG. 7, is the prior art for actuating an individual stationary, oil-injected screw compressor.

If the pressure p_{K} at the exit of the screw compressor undershoots the adjustable threshold value pᵤ, the demand for load is set. If the pressure p_{K} at the exit of the screw compressor exceeds the adjustable threshold value Pₒ, the load demand is reset. A set load demand has the effect that the screw compressor is converted to the operational state “running under load”. A reset load demand has the effect that the screw compressor departs from the operational state “running under load”.

The threshold values pᵤ, and pₒ are to be chosen such that adherence to the limits pₘᵢₙ and pₘₐₓ for the measured value p at the compressed air reservoir is guaranteed. Two aspects have to be considered in terms of adhering to the limits:
1. Pressure reduction across the components of compressed-air processing, typically 0.5 bar cumulative across all components of compressed-air processing (relevant to pressure threshold pₒ).
2. Time lapse for converting the compressor from the operational state “standstill” to the operational state “running under load”, for example. Δt=12 s (relevant to pressure threshold pᵤ).

If one were to wish to avoid undershooting pressure pₘᵢₙ in any case (ignoring the case of compressor failure), the pressure limit pᵤ, to be chosen in the case of a known maximum compressed-air consumption \dot{V}ₘₐₓ in the case of a known volume of the compressed-air reservoir V and in the case of a known environmental pressure p_{amb} (to which the indication of maximum consumption relates) may be calculated as follows:

$${p}_{u} = {p}_{min} + \frac{{\dot{V}}_{max}}{V} \times Δ t \times {p}_{amb} \qquad Formula 7$$

If the maximum pressure reduction Δp_{DLA} across the components of compressed-air processing is known (arising when the screw compressor conveys its maximum delivery), exceeding the pressure limit pₘₐₓmay be reliably avoided in that the pressure threshold pₒ is set so as to be reduced precisely by the value of the maximum pressure reduction Δp_{DLA}.

pₒ=pₘₐₓ−Δp_{DLA} Formula 8

It is in particular the pressure limit pᵤ, which has been chosen in this conservative manner that causes maximal positive adherence to the pressure limits, on the one hand. By using this approach, pressure qualities of 100% may be achieved, pressure quality to be understood to be the comparative proportion of time during which the pressure p_{K} has been located within the stated pressure limit pᵤ, and pₒ. However, for two reasons this is achieved at the cost of increased demand for electrical power:

1. By increasing the pressure threshold pᵤ, the average pressure is also increased. The higher the average pressure, the higher the input of electrical power in the operational state “running under load”.

2. Increasing the pressure threshold pᵤ, at a constant pressure threshold pₒ means a reduction in the width of the hysteresis. This leads to an increase in the number of changes of the operational state. In principle, a higher number of changes in the operational state also means an increase of the input of electrical power (there are exceptions, however).

The frequency of change in the operational state is established by way of the spacing of pₒ from pᵤ. The larger the spacing, the more rarely is the operational state changed, and the fewer the instances of the additional work for motor start-up, pressure build-up, and pressure reduction. At the same time the average pressure increases, reflected in an increased input of power in the operational state “running under load”.

In practice a spacing of 0.5 bar is often used between pₒ and pᵤ, ₚᵤ forming the basis for the calculation of pᵤ (a low pressure level is envisaged). The spacing of 0.5 bar is a compromise which enables satisfactory energy efficiency of the compressed-air generation both at low as well as at high compressed-air consumption. However, good or very good energy efficiencies cannot be achieved using this approach, since a major or minor spacing between pₒ and pᵤ leads to optimal results, depending on the compressed-air consumption. The in-principle correlation between utilization and optimal spacing between pₒ and pᵤ is illustrated in a stylized form in FIG. 8.

Proceeding from a continuously running screw compressor (utilization 100%), the optimal spacing of pₒ from pᵤ initially rises in a continuous manner as utilization drops. This can be explained in that the switching frequency drops when the spacing of pₒ to pᵤ increases and, on account thereof, the lost work for changing operational states is reduced. The increased input of power on account of the increased average pressure in the operational state “running under load” is over-compensated for up to a certain degree of utilization. Below this degree of utilization, the optimal spacing is again reduced, since the additional load output which arises would no longer be compensated for by way of a constant or further increasing spacing of the pressure bandwidth limits.

On account of the functional mode described above, two substantial disadvantages result in the prior art:

1. On account of the safety spacing of pᵤ from pₘᵢₙ, which is conceived for the maximum compressed-air consumption, an unnecessarily high average pressure which leads to increased input of power in the operational state “running under load” results in instances of comparatively low compressed-air consumption.

2. As is illustrated in FIG. 8, the statically established limits pₒ and pᵤ are really optimal for one (or two) specific degrees of utilization. In the case of variable compressed-air consumption, which in practice is the rule rather than the exception, the spacing of pₒ from pᵤ should be adapted to the variable compressed-air consumption (and thus to the variable degree of utilization).

Solutions which by means of simulation models attempt to improve the operation of a stationary, oil-injected screw compressor in that it is determined by means of a simulation model of a component (here the stationary, oil-injected screw compressor 11 being observed) according to FIG. 4 which effects the use of a given pair pᵤ and pₒ at a likewise given temporal profile of the consumption of compressed air would have on pressure quality and energy efficiency of compressed-air generation are proposed in hereunder. It will also be discussed here how further variables may be derived from variables which are available in the controller by evaluating models, which further variables are then further processed in other models.

By applying the exemplary embodiment which is described hereunder (in the following referred to as control example 1), the operator of the screw compressor obtains the potential to choose in a finely graduated manner between an energy-efficient operational mode of the screw compressor and an operational mode having a high probability for adhering to given pressure limits. Establishing the operational mode may be manually performed, on the one hand, in that the operator uses the model stored in the compressor controller for calculating the effects on adhering to the pressure limits pₘᵢₙ and pₘₐₓ for the pressure thresholds pᵤ and pₒ, which have been predefined by the operator, and the energy efficiency of compressed-air generation, and, based on the model evaluations, to establish himself/herself the pressure thresholds pᵤ and pₒ used for determining the load command. Alternatively, the operational mode may also be established in a fully automatic manner in that the operator defines limit values for key figures which describe the extent of violations of the pressure limits, and an optimization algorithm based on the limit values self-sufficiently determines the pressure thresholds pᵤ and pₒ for which the pressure limits are adhered to, at the same time maximizing the energy efficiency of compressed-air generation.

The fundamental idea of the control example 1 lies in that the one optimal combination of pₒ and pᵤ is determined by means of a simulation model of the components, according to FIG. 4, and by means of a predefined profile of the consumption of compressed-air, said combination then being used as is known per se and as has been described above for calculating the load demand by way of a two-position controller having a hysteresis.

The simulation model is composed of a model of the component (here of the screw compressor 11) which also conjointly considers the structure and the behavior of the compressed-air reservoir 14. The behavior of the compressor controller in terms of calculating the load demand by way of a two-position controller having a hysteresis with the pressure limits pₒ and pᵤ is also considered in the model of the screw compressor. The simulation model is a physical and logical model.

The simulation model replicates the component (here the stationary, oil-injected screw compressor 11) from FIG. 4 in such a manner that the temporal profile of the pressure p and the total input of power of the screw compressor for the simulation horizon (in this case corresponding to the time span covered by the predefined profile of the consumption of compressed-air) are determined by means of the simulation model using a predefined temporal profile of the compressed-air consumption and of the pressure thresholds pₒ and pᵤ, (see FIG. 9).

By way of the simulation model it may be calculated for a given temporal profile of the compressed-air consumption which temporal profiles of pressure and of electrical power input would result (in the context of the accuracy of the model) when specific pressure thresholds pₒ and pᵤ are applied in the real component (in the screw compressor 11 observed here).

The simulation model is adapted to the specifically given component or part-component by parameterization or configuration, respectively. This is performed by pre-defining the properties (for example, the delivered amount in the operational state “running under load”, power input in the operational state “idling”, characteristic curve for the power input in the operational state “running under load”, . . . ) of the component that are to be used for evaluating the simulation model, and of the volume V of the compressed-air reservoir.

The above-mentioned properties could be predefined either by manual input or by the control devices described further above (internal controller, superordinate controller, (master) system/computing center/data center/cloud/ . . . ). Alternatively thereto, the properties may also be learned by the control device.

It is thus possible to mathematically check to which extend the pressure limits pₘₐₓ and pₘᵢₙ are adhered to for p for a given compressed-air consumption profile, having a specific combination of pressure thresholds pₒ and pᵤ, and what electrical power is required for operating the components in order to cover the compressed-air consumption.

The simulation model here runs in the controller of the screw compressor 11, which is defined as the control device 30 (see FIG. 10).

However, it is also conceivable that the simulation model runs in a controller which is defined as an external control device 32, which is not a component part of the screw compressor (see FIG. 11). It is only for the sake of completeness that mention is made of the fact that the dryer 12 in this design embodiment disposes of a dedicated control device 31.

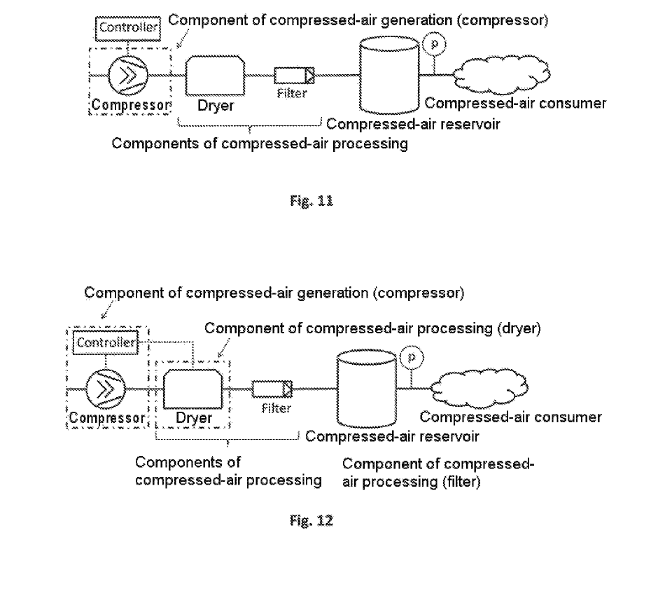

However, it is also conceivable that the simulation model runs in the control device 30 of the screw compressor 11, which device at the same time is also connected to the dryer 12 (see FIG. 12).

It is furthermore conceivable that the simulation model runs in a control device 33 which at the same time is assigned to the screw compressor and to the dryer (see FIG. 13). In this embodiment, the component in the context of the present invention is formed by a unit composed of the screw compressor 11 and the dryer 12.

It goes without saying that combinations of the various embodiments described by means of FIGS. 10 to 13 may also be present, such as an external control device 32 interacting with a control device 30 assigned to the screw compressor, or an external control device 32 interacting with a control device 33, controlling, regulating, and/or monitoring a component which is composed of the screw compressor 11 and the dryer 12.

Evaluating the simulation model here is performed with the purpose of achieving optimization of the operational behavior. Optimizing is performed with the objective of specifying the pair pₒ and pᵤ such that:

1. adherence to the pressure limit pₘᵢₙ, which is sufficiently good for the operator, is achieved,

2. adherence to the pressure limit pₘₐₓ which is sufficiently good for the operator, is achieved, and

3. electrical power input to the compressor is minimized.

Here, pₘᵢₙ and pₘₐₓ are determining factors which are communicated by the operator of the screw compressor to the compressor controller which is formed by a control device 30, 31, 32, and/or 33, or by a combination of these control devices, respectively, (for example as manually input parameter or as a message via a communication interface).

As has been described above, the temporal profile of the compressed-air consumption has to be predefined for optimizing the pressure thresholds pₒ and pᵤ. The temporal profile of the profile of compressed-air consumption could have been determined the day before, for example, or in the preceding week in the compressor system per se. In the simplest case, this is performed by direct measurement of compressed-air consumption at the measuring point p, this being rarely the case in practice, however. More often, an attempt will be made to estimate the temporal profile of compressed-air consumption by way of the profile of the pressure p_{K} observed at the exit of the screw compressor.

The effective reservoir volume V (volume of the compressed-air reservoir and of the pipeline network) is assumed to be a given and constant. The current delivered amount FAD of the screw compressor is calculated from the operational state of the screw compressor and from the pressure p_{K}:
If the screw compressor is in the operational state “running under load”, the delivered amount FAD may be determined by way of a characteristic curve (delivered amount FAD over pressure p_{K}).
If the screw compressor is not in the operational state “running under load”, the delivered amount of the compressor is 0.

The compressed-air consumption DLV may now be determined as follows by way of the pressure p from the delivered amount FAD:

$$DLV = \frac{V}{{p}_{amb}} * \frac{d p}{d t} - FAD \qquad Formula 9$$

P_{amb} characterizes the environmental pressure as absolute pressure to which the delivered amount FAD and the compressed-air consumption DLV relate. As long as the delivered amount FAD of the screw compressor is not variable, compressed-air consumption is linear in relation to the gradient of pressure p. Since pressure p is not always measured, as this is a pressure which is external to the component, reference is made back to pressure p_{K}. Assuming in a manner which is closely related to practice that, apart from contamination effects which are perceivable only over very long temporal horizons (months), the pressure reduction across the components of compressed-air processing depends exclusively on the amount delivered by the compressors, it may be assumed for the operational state “running under load” (having an approximately constant FAD) that

p_{K}=const.+p Formula 10

or, respectively,

p=p_{K}−const. Formula 11

Therefore

$$\frac{d p}{d t} = \frac{d {p}_{K}}{d t} \qquad Formula 12$$

The compressed-air consumption may thus be determined from p_{K} as follows:

$$DLV = \frac{V}{{p}_{amb}} * \frac{d {p}_{K}}{d t} - FAD . \qquad Formula 13$$

There now remains the problem that a very rapid change in pressure arises at p_{K} around the time point of the change in the operational state from “pressure build-up” to “running under load”, or from “running under load” to “pressure reduction”, respectively, since a pressure differential between p_{K} and p is built up by the delivery of compressed air setting in when the change from “pressure build-up” to “running under load” takes place, said pressure differential being reduced again when the change from the operational state “running under load” to the operational state “pressure reduction” takes place (see FIG. 14).

The buildup and reduction of the pressure differential in terms of estimating compressed-air consumption leads to incorrect values. The problem may be solved in that estimating compressed-air consumption is abandoned for a few seconds (keeping the DLV value constant, for example) whenever there is a change to or from the operational state “running under load”.

By observing the profile of pressure p_{K} when there is a change from “pressure build-up” to “running under load”, or from “running under load” to “pressure reduction” respectively, the pressure differential Δp between the measuring points p_{K} and p may also be estimated, without measuring p. In a first approximation, the pressure differential Δp between p_{K} and p corresponds to the jump in p_{K} prior to and after the change in the operational state (see FIG. 15).

The knowledge pertaining to the pressure differential Δp allows regulating to pressure p, without measuring the latter.

The compressed-air consumption profile which is determined by evaluating p_{K} is stored as a temporal profile, so as to be used later for determining new pressure thresholds pₒ and pᵤ.

If reliable adherence of the pressure limits pₘᵢₙ and pₘₐₓ is the main focus of the operator of the compressor system, the thresholds pᵤ and pₒ for calculating the load demand are to be established as has been described above. Provided that the assumptions pertaining to the temporal behavior of the screw compressor, the effective reservoir volume V, the maximum expected compressed-air consumption \dot{V}ₘₐₓ, and the absolute environmental pressure p_{amb}, which have been made for calculating pᵤ and pₒ, are correct, barring compressor failure, a pressure quality of 100% will be achieved. However, energy-optimized operation will rarely be achieved thereby.

A first possibility for optimizing the electrical energy input of the screw compressor lies in that the upper pressure threshold pₒ is no longer specified merely by means of the maximum expected compressed-air consumption but considering the temporal profile of compressed-air consumption. As has been described above, a high pₒ tends to be optimal in terms of energy in the case of low utilization, and a low pₒ tends to be optimal in terms of energy in the case of high utilization.

By evaluating a model of the screw compressor, which may contain items of information pertaining to the downstream compressed-air reservoir, it may be determined for a given temporal profile of compressed-air consumption what pressure quality results for a given pair of pressure thresholds pᵤ and pₒ in relation to a given pair of pressure thresholds pₘᵢₙ and pₘₐₓ, and what electric power input is required for generating the given compressed-air consumption. However, evaluating the model here is initiated in that the operator of the compressor system pre-defines
a combination of pressure thresholds pᵤ and pₒ,
the temporal profile of compressed-air consumption which is to be considered for evaluation (for example by indicating “last month”, “last week”, “last day”, or by inserting a temporal profile of compressed-air consumption),
and the pressure limits pₘᵢₙ and pₘₐₓ to be adhered to, and the calculation commences. The model of the component, that is to say of the screw compressor here, is initialized such prior to each evaluation that the screw compressor at the beginning of the simulation is located in the operational state “standstill”, and the pressure in the compressed-air reservoir p has a value minimally smaller than pₘₐₓ. It is to be achieved by this choice of an initial state that any violation of the pressure limits pₘᵢₙ and pₘₐₓ is excluded prior to or after the first change in the load demand. The results of evaluating the model are pressure quality and electrical power input for covering compressed-air consumption.

If for evaluating the model the operator chooses pᵤ as calculated above, and for pₒ a value greater pᵤ but smaller than or equal to the value for pₒ, the pressure quality will be 100%. By iteratively evaluating the model having variable pₒ, the operator may now determine a pₒ which reliably adheres to the predefined pressure limits pₘᵢₙ and pₘₐₓ, and minimizes the electrical power input to the screw compressor.

Provided that a pressure quality of 100% is not an absolute precondition for operating the process which is supplied with compressed air, the input of electrical power may be further reduced by lowering the pressure threshold pᵤ. The savings in electrical energy are then offset by reduced pressure quality. By iteratively evaluating the model, as has been described in the sections further above, the operator of the compressor system may determine a combination of pressure thresholds pᵤ and pₒ that minimizees the input of electrical power and at the same time (from the viewpoint of the operator) guarantees acceptable pressure quality (potentially below 100%).

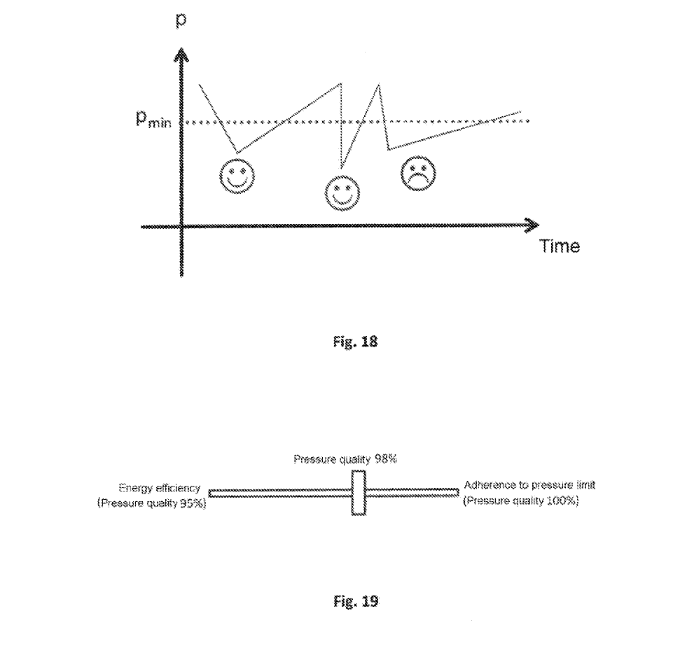

At times, pressure quality is a criterion which is too simple to choose for the operator in order to appraise adherence to the pressure limits pₘᵢₙ and pₘₐₓ, which are required for the process which is supplied with compressed air. For example, undershooting of pₘᵢₙ may not be critical to the process which is supplied with compressed air, provided that undershooting arises only for a short time. Therefore, it is meaningful to extend evaluating the model such that key figures in terms of various aspects relating to the adherence to the pressure limits pₘᵢₙ and pₘₐₓ are calculated. In an exemplary manner the following key figures may be mentioned.
Frequency of violations of the pressure limits while considering a tolerance for exceeding pₘₐₓ or undershooting pₘᵢₙ, respectively (see FIG. 16).
Minimal value and maximum value of pressure p.
Maximum time span arising for exceeding pₘₐₓ or undershooting pₘᵢₙ (see FIG. 17).
Maximum time-over-pressure area arising for exceeding pₘₐₓ or undershooting pₘᵢₙ, respectively (see FIG. 18).
Total time-over-pressure area for undershooting pₘᵢₙ.
Total time-over-pressure area for exceeding pₘₐₓ.

To this extent, individual pressure quality criteria may be established, calculated, and/or monitored, and in this way be considered when establishing pᵤ and pₒ.

Assuming that the temporal profile of compressed-air consumption may be transported from the past (within limits) to the future, or that compressed-air consumption over time that has been uploaded to the controller is representative, respectively, the two-position controller may be adapted to the process which is supplied with compressed air, using data which is located in the controller.

Determining energy-optimal pressure thresholds pᵤ and pₒ may however also be automated, as will be described hereunder.

The compressed-air consumption profile (which has been stored as a historical determining factor in the compressor controller) is periodically used (for example, daily or weekly) for determining new values for the pressure thresholds pₒ and pᵤ. This is performed by multiple evaluations of the simulation model, using various configurations in terms of pₒ and pᵤ.

In this exemplary embodiment the one-time evaluation of the simulation model does not provide any statement as to by way of what pair of pₒ and pᵤ the lowest input of electrical power of the compressor may be achieved while at the same time adhering to the pressure limits. To this end, multiple evaluations of the simulation model may be carried out, using various pairs of pₒ and pᵤ.

A primitive possibility for generating combinations of pₒ and pᵤ to be tested lies in that the interval for meaningful pressure limits, which may be defined, for example, by pₘᵢₙ and the maximum permissible pressure pₕ at the exit of the screw compressor, is subdivided into equidistant portions (for example, of 50 mbar width). The combinations of pₒ and pᵤ to be tested are now simply generated by listing all meaningful formations of pairs of portion limits. Here, only pairs in which pₒ is above pᵤ are meaningful. As an example, it is assumed that pₘᵢₙ is 7 bar, ph is 8 bar, and the portion width is 100 mbar. In this instance, the following combinations of pₒ and pᵤ would be investigated:
pᵤ=7.0 bar: pₒ ∈{7.1 bar; 7.2 bar; . . . , 7.9 bar; 8.0 bar}→10 combinations
pᵤ=7.1 bar: pₒ ∈{7.2 bar; 7.3 bar; . . . ; 7.9 bar; 8.0 bar}→9 combinations
Pᵤ=7.2 bar: pₒ ∈{7.3 bar; 7.4 bar; . . . ; 7.9 bar; 8.0 bar}→8 combinations
pᵤ=7.3 bar: pₒ ∈{7.4 bar; 7.5 bar; . . . ; 7.9 bar; 8.0 bar}→7 combinations
. . .
pᵤ=7.8 bar: pₒ ∈{7.9 bar; 8.0 bar}→2 combinations
pᵤ=7.9 bar: pₒ ∈{8.0 bar}→1 combination

In total 55 combinations are checked in the example. For every check the simulation model is initialized such that the screw compressor at the beginning of the simulation is located in the operational state “standstill”, and the pressure in the compressed-air reservoir p has a value minimally smaller than pₘₐₓ. By this choice of the initial state it is to be achieved that any violation of the pressure limits pₘᵢₙ and pₘₐₓ prior to or after the first change in the load demand is excluded.

By way of the evaluation of the simulation model as described herein, operational data and operational states of the screw compressor and of the compressed-air reservoir (temporal profile of pressure p, temporal profile of the input of electrical power of the screw compressor, temporal profile of the operational state of the screw compressor, . . . ) that are fundamentally fictitious are created. The operational data and the operational states are fundamentally fictitious since during the evaluation of the simulation model for the real observed compressed-air consumption configurations for the pressure thresholds pₒ and pᵤ that were never applied in the real compressor controller to cover the real observed compressed-air consumption are used to calculate the load demands.

Operational data for which no measured values/sensor values are available to the compressor controller is deduced in evaluating the simulation model. The former includes, for example, the input of electrical power of the screw compressor, which is dependent on the operational state, or the pressure p.

While the simulation model is being evaluated (multiple times), the screw compressor continues to be operated in an entirely normal manner. In order for the load demand to be calculated, the two-position controller having a hysteresis uses the pressure thresholds pₒ and pᵤ, such as have been determined to be energy-optimal in the last optimizing cycle (for example, a day or a week before).

In order for a combination of pressure thresholds pᵤ and pₒ to be appraised, pressure quality or the key figures for appraising adherence to the pressure limits pₘᵢₙ and pₘₐₓ (the individual established, establishable, or calculated pressure quality criteria) is/are evaluated. Evaluating is performed by way of a comparison with limit values for pressure quality or for the key figures which have been stored by the operator of the compressor system in the controller, respectively. All combinations in which pressure quality or the key figures, respectively, violate the limit values predefined by the operator are dismissed. Of the remaining combinations, that combination which for the given temporal profile of compressed-air consumption leads to the lowest input of electrical energy is then selected and used in the real two-position controller having a hysteresis for calculating the load demand.

Alternatively to pre-defining in a detailed manner limit values for pressure quality or for the key figures, respectively, the operator of the system may also be made to undertake abstract predefined weighting between an energy-efficient operational mode and an operational mode having high probability in terms of adherence to the pressure limits. Taking pressure quality as the relevant variable for adherence to the pressure limits, the operator may be left to choose a minimum pressure quality to be adhered to (for example, by way of a slide control). The position of the slide control here is scaled to between 95% and 100% in relation to the minimum pressure quality to be adhered to, as is illustrated in FIG. 19.

From the point of view of the operator, the issue when establishing the minimum pressure quality to be adhered to is weighing up a high probability of adhering to the predefined pressure limits at high energy costs, against a lowered probability of adhering to the predefined pressure limits at low energy costs.

The comparatively simple method of generating the combinations to be tested by way of an equidistant division of the meaningful pressure interval has the disadvantage that values of pressure thresholds which lie between the equidistant pressure thresholds are not checked. This leaves optimization potential unutilized. By employing a stochastic optimizing method, such as simulated annealing, genetic optimizing, differential evolution, . . . , for example, it is possible to determine the optimal combination of pₒ and pᵤ, without discretization of the thresholds to be tested for pₒ and pᵤ. However, it is in this instance no longer predictable how many evaluations of the model have to be carried out until the optimal solution has been found.

The methods proposed above, despite the improvements in relation to the prior art, nevertheless have two disadvantages:
1. Optimizing the pressure thresholds pₒ and pᵤ is performed for a time period of a plurality of hours or days, and thus typically for a temporal profile of compressed-air consumption that causes phases having low, medium, and high utilization of the screw compressor. By trend, different energy-optimal thresholds result for different degrees of utilization, as is illustrated in FIG. 8. The pressure thresholds pₒ and pᵤ, which have been determined by optimizing, thus cannot lead to optimal results in terms of energy efficiency for every situation; they are rather the pressure thresholds which on average lead to best energy efficiency.
2. Optimizing the pressure thresholds pₒ and pᵤ is typically performed based on a temporal profile of compressed-air consumption (for example, the temporal profile of compressed-air consumption of the past week) that has been observed in the past. Optimizing thus only leads to positive results when the temporal profile of compressed-air consumption may also be transported from the past to the future.

The first of the two disadvantages described above may be counteracted in that the temporal profile of compressed-air consumption which is being drafted for optimizing the pressure thresholds pₒ and pᵤ is shortened and instead a plurality of pressure thresholds pₒ and pᵤ which are alternatively applied are optimized. For example, when it is known that the temporal profile of compressed-air consumption is significantly different on weekdays Monday to Friday (normal production) than on weekend days Saturday and Sunday (no production, compressed-air consumption substantially through leakages), it is then meaningful that other pressure thresholds pₒ and pᵤ are optimized and used for weekdays Monday to Friday than for weekend days Saturday and Sunday.

To this extent, it is also provided according to one advantageous aspect of the present invention that dissimilar pressure thresholds pₒ and pᵤ are provided for dissimilar operational situations, in particular for dissimilar time periods.

However, the second of the two disadvantages described above cannot be counteracted in the controller of the component per se, here the controller of the screw compressor. If the temporal profile of compressed-air consumption that is to be expected in the future cannot be derived from observations made in the past, knowledge pertaining to the future behavior of the process which consumes the compressed air is necessary in order to know which temporal profile of compressed-air consumption the pressure thresholds pₒ and pᵤ are to be optimized for. If a prognosis of the future temporal profile of compressed-air consumption is possible neither by way of observations in the past nor by way of procuring external information, simulation-based calculation of the load demand, as is proposed hereunder in the exemplary controller 2, is available instead of optimizing rigid pressure thresholds.

The exemplary controller 2 is an exemplary embodiment of the present invention, wherein a cyclical algorithm using simulations in real time (for example, once per second) determines here whether it is meaningful in terms of energy for the currently prevailing compressed-air consumption and the currently assumed operational state of the screw compressor (cf. FIG. 20), to change the load demand. Here the pressure limits pₘᵢₙ and pₘₐₓ which are predefined for the measuring point p are also considered.

As compared with the exemplary controller 1, carrying out simulations in the exemplary controller 2 has another purpose. In the case of the exemplary controller 1 the application of simulations serves for determining by way of which pressure thresholds one would have covered a temporal profile of compressed-air consumption in the past at the lowest input of electrical power, so as to use the thus determined pressure thresholds pₒ and pᵤ for determining the load command in the future. The algorithms for calculating the load demand in the simulation model and in the real compressor controller are identical (two-position controller having a hysteresis). The purpose of carrying out simulations in the exemplary controller 1 is that of optimizing control parameters (thresholds pₒ and pᵤ).

In the exemplary controller 2, evaluating the simulation model becomes an integral component part of determining the load demand per se. In the simulation model, and in the real controller of the component (here the compressor controller), different algorithms are used for calculating the load demand.

The simulation model for the exemplary controller 2 is identical to the simulation model in the exemplary controller 1. A physical logical model of the screw compressor, which also considers items of information pertaining to the specific connected compressed-air reservoir, is used as the basis.

It is the fundamental idea of the exemplary controller 2, proceeding from the current situation in a compressor system having an assumed structure as per FIG. 4, to investigate by means of carrying out a plurality of simulation runs on a simulation model of the compressor system whether in terms of energy it is more advantageous for the load demand to be initially kept unchanged, or for the load demand to be changed. To this end, various pairs of pressure thresholds pₒ and pᵤ are investigated on the simulation model. As has already been mentioned, an exemplary algorithm cycle is illustrated in FIG. 20.

The algorithm cycle commences in that the current state of the compressor system is detected and stored. The current state here is to be understood to mean current compressed-air consumption (determined from the pressure gradient of p_{K}, for example), the pressure in the compressed-air reservoir p (determined from p_{K}, for example), and the operational state of the screw compressor. Subsequently, pairs of pressure thresholds pₒ and pᵤ to be tested are formed. Forming of the pairs may be performed by discretization of the interval pₘᵢₙ to pₕ, for example, as has been described above. Subsequently an evaluation of the simulation model is carried out for each pair pₒ and pᵤ, so as to check the adherence to the pressure limits pₘᵢₙ and pₘₐₓ for a fictitious profile of the pressure p, and to determine the fictitious input of electrical power of the screw compressor.

Prior to beginning an evaluation of the simulation model, the simulation model is initialized using the state of the compressor system that has been stored immediately after the beginning of the algorithm cycle. Evaluating the simulation model in this way is performed within one algorithm cycle for all pairs of pₒ and pᵤ, always proceeding from the same items of information pertaining to the current real state of the compressor system (here operational data and operational state, for example) that are available in the controller of the component (here the compressor controller).

The fictitious temporal behavior of the compressor system is calculated by simulation for the near future, using a certain configuration for pₒ and pᵤ. Near future here is to be understood as a time span of approx. one minute up to approx. 1 h. The length of the time span is inter alia determined by the dimensioning of the compressor system. The results of a simulation are (at least):
the fictitious temporal profile of pressure p
the fictitious temporal profile of electric power E
the fictitious temporal profile of the delivered amount of the compressor FAD.

It may be checked by means of the simulation result whether the predefined pressures pₘᵢₙ and pₘₐₓ at the measuring point p would be adhered to when actuated using pₒ and pᵤ, and what input of power arises for generating what amount of pressure (→calculating the specific output).

If a simulation was carried out for every pair of pₒ and pᵤ, it is thus determined for which pair of pₒ and pᵤ the best result has been achieved. The best result may be considered that simulation result, for example, in which the pressure limits are not violated and additionally the lowest input of electrical power has been observed for the simulated time period. Instead of the input of electrical power, the specific output (quotient of input of electrical power E and delivered amount of the compressor FAD at the end of the simulated time period) may also be observed. Further variants of evaluating are conceivable. In order to prevent the exclusion of positive simulation results in terms of energy, only because the pressure thresholds pₘᵢₙ and pₘₐₓ are violated in an insignificant manner, it is proposed that the check for adherence to the pressure limits is provided with tolerances, such as shown in an exemplary manner in FIGS. 16, 17, and 18.

It is determined for the best pair of pₒ and pᵤ which has been determined, whether the current pressure p_{K} lies within the interval pᵤ to pₒ. If a plurality of best pairs pₒ and pᵤ have been determined, the first best pair pₒ and pᵤ (in terms of the sequence of the evaluation in the simulation model) is used for the check. If pressure p_{K} is within the interval, the current state of load demand is maintained. If pressure p_{K} is outside the interval, the load demand is inverted.

If there is no pair of pₒ and pᵤ (possibly despite a tolerance being applied) for which the pressure limits pₘₐₓ and pₘᵢₙ are adhered to, it is thus checked whether pressure p_{K} lower than pₘᵢₙ; if so, the load demand is set. Otherwise, it is checked whether pressure p_{K} is higher than pₘₐₓ; if so, the load demand is reset. If the latter also does not apply, the load demand remains unchanged.

As has been described above, cf. FIGS. 5 to 7, the operational state is influenced by way of the load demand. If the load demand is set, the screw compressor is converted to the operational state “running under load”. If the load demand is reset, the screw compressor is converted to the operational state “idling” or “standstill”, respectively.

Since evaluating the simulation model serves for calculating the load demand, it is clearly to be seen that evaluating the simulation model is carried out while the screw compressor is being operated.

It is to be presented once again hereunder how a simulation model may be evaluated in particular by way of integration of time.

Proceeding from an initial time point and from an initial state, the temporal behavior of the system described by the model is calculated. The temporal behavior here is calculated in that, proceeding from the current state, it is determined in the model where the model will be located in the following temporal step. To this end, a numerical integration method (for example, the trapezoid method, or the Runge-Kutta method) is preferably applied. The simulation, that is to say the repeated application of numerical integration in order to move from one temporal step to another, is carried out until an abort criterion is reached.

The abort criterion may on one hand be reaching the end of the simulation horizon that has been defined prior to the beginning of numerical integration. The simulation horizon characterizes the time range which is to be covered by the simulation.

Alternatively or cumulatively, a condition which is defined based on variables which are calculated during the simulation may also be used as an abort criterion. While numerical integration is carried out iteratively, it is checked whether the condition has been met. If this is the case, numerical integration and thus the simulation are terminated.

In principle, the result obtained from a simulation is time series of variables which are described by the model. The time series are most often processed after a simulation has been carried out, for example in that new time series are calculated from already existing time series (for example, determining the temporal profile of the total power input by summarizing the time series of the input power of the individual compressors), or that key figures are calculated from time series (for example, calculating the specific output from the initial time point of the simulation up to the end of the simulation horizon).

A simulation is appraised in the last step, for example by way of comparison with simulations which have already been carried out. A target function which allows a comparison of the processed simulation results in the sense of “better than” or “worse than”, respectively, is used for appraising. In many instances appraising a simulation is only meaningful when a plurality of simulations have been carried out. Appraising takes place by way of the appraisal horizon. In principle, the appraisal horizon corresponds to the simulation horizon, but the appraisal horizon may also deviate from the simulation horizon.

Evaluating a model which here is configured as a simulation model, will be discussed in more detail with reference to FIGS. 22 and 23. In particular with a view to the present invention in one preferred design embodiment proposing that the evaluation routines are initialized, carried out, evaluated, and used in an event-driven manner, in particular in the case of predefined determining factors, operational states, operational modes, and/or when malfunctions or defects of the component arise, the question is put forward as to the sequence in which the individual steps are carried out or initialized, respectively. In general, the following applies:
Initializing the model is event-driven (Step 3a in FIGS. 22 and 23).
Carrying out analyses of the model is event-driven (step 3c in FIGS. 22/23).
Appraising simulation results is event-driven (step 3d in FIGS. 22 and 23).
In the case of a parallel simulation being applied (cf. FIG. 23) it may be interesting for steps 3a and 3c to be carried out once or rarely in an event-driven manner, but for step 3d to be carried out very often in a cyclical manner.
Use is event-driven (cf. steps 5 and 6 in FIGS. 22 and 23).

In general, it is pointed out that an application case of the sequence illustrated in FIG. 22 may be that of calculating a control/regulating step. The sequence of some steps may vary, however. FIG. 22 does not apply to parallel simulations. The latter may be carried out using a sequence as per FIG. 23. An application case of the sequence as per FIG. 23 is the virtual moisture content sensor, for example. The order of some steps may also vary in the sequence as per FIG. 23.

It is to be pointed out that the respective events which in an event-driven manner trigger the individual steps may be dissimilar for the various steps, but need not be dissimilar.

For the sequence of individual steps presented in FIG. 23, it is to be pointed out with a view to step 3a that initializing must be performed in the first pass, whereas initializing is carried out in the following passes in an event-driven manner, that is to say only on demand. It is pointed out with reference to step 3c that a temporal step is calculated in every cycle in the model (the time period which has elapsed since the last cycle). However, it may be advantageous for the temporal step to be subdivided into a plurality of integration steps.

### LIST OF REFERENCE SIGNS

11 Screw compressor

12 Dryer

14 Compressed-air reservoir

15 Compressed-air network

16 Transfer point

17 Air filter

18 Motor

19 Compressor

20 Oil trap container

21 Minimum-pressure check valve

22 Air cooler

23 Compressor exit

24 Compressor entry

25 Inlet valve

26 Bypass line

27 Venting valve

28 Breakout point

29 Connector point

30 Control device (Screw compressor)

31 Control device (Dryer)

32 External control device

33 Control device (common to screw compressor and dryer)

1. An electronic control device for a component of compressed-air generation, compressed-air processing, compressed-air storage, and/or compressed-air distribution,
wherein the electronic control device (11) for determining, replicating, or evaluating operationally relevant data refers back to one or a plurality of models which as component-related models contain items of information which are relevant to the structure or to the behavior of the component (12),
and by means of the models as an evaluation purpose in a specific evaluation routine either performs
controlling, regulating, diagnosing, and/or monitoring of the component, or
determining, providing, predicting, or optimizing operational data, operational states, operational modes, operational behavior, and/or operational effects,
and
wherein current or historical items of structural information, operational data, operational states, and/or measured values/sensor values of the component which are at least in part available in the electronic control device are used as initial values.

2. The electronic control device as claimed in claim 1, wherein the electronic control device, depending on the evaluation purpose, performs variable configurations
of the component models or else of part-component models, and/or
of the type, the number, the sequence, and/or the scenarios of the evaluations.

3. The electronic control device as claimed in claim 1, wherein the component model or else the part-component model is adapted to the properties and/or the operational parameters of the (part-)component(s) that have to be specifically considered in the respective evaluation by parameterization or configuration, respectively, wherein adapting may be performed in particular manually, part-automatically, or automatically.

4. The electronic control device as claimed in claim 1, wherein that by means of the models also operational data, operational states, and or state quantities of the component, for which the measured values/sensor values are not or not yet available, are carried over and/or deduced in the evaluation process.

5. The electronic control device as claimed in claim 1, wherein that, depending on the evaluation purpose, reference is made back to variable initial values, and/or variable initialization time points are chosen.

6. The electronic control device as claimed in claim 1, wherein the evaluation process takes place during operation of the component.

7. The electronic control device as claimed in claim 1, wherein the evaluation process for a certain behavior, in particular for the operational behavior of the component, is carried out by means of a component model, so as to be temporally prior to said operational behavior, or during said operational behavior, or subsequent to said operational behavior.

8. The electronic control device as claimed in claim 1, wherein the evaluations are fully or partially composed of the analysis of models, in particular of the analysis of logical models.

9. The electronic control device as claimed in claim 1, wherein the component models are present as:
physical,
logical,
structural,
stochastic,
monetary,
empirical,
appraised, and/or
models combined from these categories.

10. The electronic control device as claimed in claim 1, wherein said electronic control device is at least partially, but in particular is also entirely configured as a controller which is integrated in the component for compressed-air generation, compressed-air processing, compressed-air storage, and/or compressed-air distribution.

11. The electronic control device as claimed in claim 1, wherein said electronic control device is at least partially not configured within the components for compressed-air generation, compressed-air processing, compressed-air storage, and/or compressed-air distribution.

12. The electronic control device as claimed in claim 1, wherein the evaluation routines which are specifically capable of being carried out comprise the execution of simulations by calculating or estimating the temporal development of operational data, operational states, and/or state quantities of the component, in particular by the numerical integration over time of model equations.

13. The electronic control device as claimed in claim 4, wherein the operational data, operational states, and or state quantities of the components, which are used and/or deduced when carrying out the evaluations, for which sensor values are not or not yet available, comprise
the state of servicing, of wear, or of aging of the component,
state quantities for which current values are not measurable or measurable only in a limited manner, and/or of which the values depend on the entire temporal profile of the operation of the component since the last service or refurbishment, or
state quantities which are only detectable, in particular measurable, in an inaccurate, cost-intensive, and/or error-prone manner.

14. The electronic control device as claimed in claim 1, wherein configuring of the models is performed by adapting the model structure depending on the part-components which are occasionally (optionally) contained in the component or are in operation, wherein adapting the model structure in particular includes parameterization.

15. The electronic control device as claimed in claim 1, wherein configuring of the models is performed by linking part-models which are assigned part-components which are at all times and/or occasionally or optionally contained in the component or in operation.

16. The electronic control device as claimed in claim 1, wherein adapting of the model structure is performed
by manual input, in particular at the electronic control device,
by transferring configuration data sets and parameter data sets into the electronic control device,
in a self-teaching manner by simulations based on iteratively adapted models, and/or
based on an Piping and instrumentation diagram of the component, which is stored in the electronic control device.

17. The electronic control device as claimed in claim 1, wherein the results of the evaluations which have been carried out by one or a plurality of models are used for initializing evaluations by further models, and/or as predefined determining factors therefor.

18. The electronic control device as claimed in claim 1, wherein configuring the type, the number, the sequence, and/or the scenarios of the evaluations comprises simultaneously or sequentially carrying out a plurality of evaluations for alternative future profiles of predefined determining factors, in particular of control commands for changing the operational mode or the operational state, and in that selecting the most favorable profiles of predefined determining factors is performed as a consequence of an appraisal of the evaluation results.

19. The electronic control device as claimed in claim 1, wherein appraising the evaluation results and selecting the most favorable future profiles of predefined determining factors is performed while employing at least one target function which contains one or more of the following criteria:
energy consumption, energy costs,
maximum value of electrical power input,
number of changes of the operational state,
utilizable amount of waste heat, and/or temperature level of the waste heat,
proportional service costs caused in the simulation horizon,
pressure condensation point,
pressure quality.

20. The electronic control device as claimed in claim 19, wherein controlling and/or regulating of the component comprises implementing the selected most favorable profiles of predefined determining factors.

21. The electronic device as claimed in claim 1, wherein temporal profiles of operational data, of operational states, and/or of state quantities of the component that have been obtained from evaluations of past time periods or are otherwise predefined, in particular calculated, are compared with real current or historical measured values/sensor values, wherein deviations between evaluation results and measured values/sensor values are used for identifying and diagnosing malfunctions or defects.

22. The electronic control device as claimed in claim 1, wherein for diagnosing malfunctions and defects, alternative evaluations with configurations of models that contain variable potential malfunctions or defects are carried out, wherein in a comparison step for identifying the most likely malfunction or the most likely defect, respectively, the respective degree of similarity between alternative evaluation results and real, current or historical measured values/sensor values are drafted, or at least less likely or unlikely error sources (malfunctions and defects), respectively, are excluded as a result of the comparison step, respectively.

23. The electronic control device as claimed in claim 1, wherein in order for malfunctions or defects to be identified, plausibility criteria for real measured values/sensor values are deduced from structural models, and the adherence of real, current or historical measured values/sensor values to these plausibility criteria is checked.

24. The electronic control device as claimed in claim 23, wherein the plausibility criteria in particular include the comparison of temperatures and/or of pressures at measuring points which are disposed upstream and downstream of one another in flow paths of media (compressed air, cooling air, cooling water, . . . ), wherein systematic increases or decreases in temperatures and/or pressures arise or are to be expected, respectively, between the measuring points during the trouble-free operation of the components.

25. The electronic control device as claimed in claim 1, wherein the evaluation routines are initialized, carried out, evaluated, and used in an event-driven manner, in particular upon a change in predefined determining factors, operational states, and/or operational modes of the component, or in the case of a diagnosis being demanded.

26. The electronic control device as claimed in claim 25, wherein the evaluations are initialized, carried out, evaluated, and used in a cyclical manner, in particular when calculating control actions, at a frequency of 1*10⁻³ s or less to 1 min, particularly preferably of 2*10⁻³ s to 10 s.

27. The electronic control device as claimed in claim 1, wherein the simulation horizon when calculating control actions preferably is 1 s to 15 min, particularly preferably 1 min to 5 min.

28. A method for controlling, regulating, diagnosing, and/or monitoring a component of compressed-air generation, compressed-air processing, compressed-air storage, and/or compressed-air distribution, wherein the component interacts with an electronic controller in particular as claimed in claim 1,
wherein for determining, replicating, or evaluating operationally relevant data reference is made back to models which as component-related models contain items of information which are relevant to the structure or to the behavior of the component, and
current or historical items of structural information, operational data, operational states, and/or measured values/sensor values of the component which are at least in part available in the electronic control device are used as initial values.

29. The method as claimed in claim 28, wherein determining, providing, prediction, or optimizing operational data, operational states, operational modes, operational behavior, and/or operational effects is also performed in, the context of diagnosing, and/or controlling, regulating, and/or monitoring.

30. The method as claimed in claim 28, wherein by means of the models also operational data, operational states, and/or state quantities of the component, for which the measured values/sensor values are not or not yet available, are carried over and/or deduced in the evaluation process.

31. The method as claimed in claim 28, wherein simulations by calculating or estimating the temporal development of operational data, operational states, and/or state quantities of the components, in particular by the numerical integration over time of model equations, are (also) carried out in the evaluation process.

32. The method as claimed in claim 28, wherein the results of the evaluations carried out by one or a plurality of models are used for initializing and/or as predefined determining factors for evaluations with further models.

33. The method as claimed in claim 28, wherein the evaluation process is carried out during operation of the component.

34. The method as claimed in claim 28, wherein the evaluation process for a certain operational behavior of the component is carried out by means of a component model so as to be temporally prior to said operational behavior, or during said operational behavior, or subsequent to said operational behavior.

35. The method as claimed in claim 28, wherein the operational data, operational states, and/or state quantities of the components, which are used and/or deduced when carrying out the evaluations, for which sensor values are not or not yet available, comprise
the state of servicing, of wear, or of aging of the component,
state quantities for which current values are not measurable or measurable only in a limited manner, and/or of which the values depend on the entire temporal profile of the operation of the component since the last service or refurbishment, or
state quantities which are only detectable, in particular measurable, in an inaccurate, cost-intensive, and/or error-prone manner.

36. The method as claimed in claim 28, wherein configuring the type, the number, the sequence, and/or the scenarios of the evaluations comprises simultaneously or sequentially carrying out a plurality of evaluations for alternative future profiles of predefined determining factors, in particular of control commands for changing the operational mode or the operational state, and in that a selection of the most favorable profiles of predefined determining factors is performed as a consequence of an appraisal of the evaluation results.

37. The method as claimed in claim 28, wherein appraising the evaluation results and selecting the most favorable future profiles of predefined determining factors is performed while employing target functions which contain in particular a combination of two or more of the following criteria for the simulation horizon:
energy consumption, energy costs,
maximum value of electrical power input,
number of changes of the operational state,
utilizable amount of waste heat, and/or temperature level of the waste heat,
proportional servicing costs caused in the simulation horizon.

38. The method as claimed in claim 28, wherein temporal profiles of operational data, of operational states, and/or of state quantities of the component that have been obtained from evaluations of past time periods or are otherwise predefined, in particular calculated, are compared with real current or historical measured values/sensor values, wherein deviations between evaluation results and measured values/sensor values are used for identifying and diagnosing malfunctions or defects.

39. The method as claimed in claim 28, wherein for diagnosing malfunctions and defects, alternative evaluations with configurations of models that contain variable potential malfunctions or defects are carried out, wherein in a comparison step for identifying the most likely malfunction or the most likely defect, respectively, the respective degree of similarity between alternative evaluation results and real, current or historical measured vales/sensor values is considered, or at least less likely or unlikely error sources (malfunctions and defects), respectively, are excluded as a result of the comparison step, respectively.

40. The method as claimed in claim 28, wherein in order for malfunctions or defects to be identified, plausibility criteria for real measured values/sensor values are deduced from structural models, and the adherence of real, current or historical measured values/sensor values to these plausibility criteria is checked.

41. The method as claimed in claim 28, wherein the evaluations are carried out on demand by a superordinate electronic controller.
